(19) United States
(12) Patent Application Publication
(10) Pub. No.: US 2026/0064728 A1
(43) Pub. Date: Mar. 5, 2026

(54) FILE ARCHIVE FOR GEOGRAPHIC RASTER DATA

(71) Applicant: ELLIPSIS EARTH INTELLIGENCE B.V., kamer B22 (NL)

(72) Inventor: Daniel VAN DER MAAS, Amsterdam (NL)

(21) Appl. No.: 19/105,750

(22) PCT Filed: Sep. 14, 2023
(86) PCT No.: PCT/EP2023/075343

§ 371 Date: Feb. 21, 2025

(30) Foreign Application Priority Data
Sep. 15, 2022 (NL) 2033044

(51) Int. Cl. G06F 16/29; G06F 16/22

(52) U.S. Cl. CPC G06F 16/29; G06F 16/2264

(57) ABSTRACT

This invention pertains a to computer-implemented data structure, a computer-implemented data structure collection, computer-readable storage media, methods, and a computer program for storing and retrieving geographic data comprised in a multi-level tiled map. The invention further pertains to a geographic information system comprising the computer-implemented data structure and/or the computer-implemented data structure and configured to execute the methods for storing and retrieving geographic data comprised in the multi-level tiled map. The computer-implemented data structure is suitable for storing and retrieving geographic data organized in a tile pyramid of the multi-level tiled map, wherein coordinates of a tile of the tile pyramid of the multi-level tiled map in a tile coordinate system of the tile pyramid of the multi-level tiled map define a metadata location, within the geographic metadata comprised in the computer-implemented data structure, of a data pointer to a data location, within geographic data comprised in the computer-implemented data structure, of geographic tile data associated with the tile of the tile pyramid of the multi-level tiled map. The computer-implemented data structure collection for storing and retrieving geographic data of the multi-level tiled map comprising a plurality of tile pyramids, the computer-implemented data structure collection comprising a plurality of computer-implemented data structures.

### TECHNICAL FIELD

This invention pertains to computer-implemented data structures for storing and retrieving geographic data comprised in a tile pyramid of a multi-level tiled map and to computer-implemented data structures for storing and retrieving geographic data comprised in a multi-level tiled map. This invention further pertains to computer-readable storage media storing geographic data comprised in a tile pyramid of a multi-level tiled map and to computer-readable storage media storing geographic data comprised in a multi-level tiled map. This invention further pertains to methods for storing and retrieving geographic data comprised in a tile pyramid of a multi-level tiled map and to methods for storing and retrieving geographic data comprised in a multi-level tiled map. This invention further pertains to a computer program comprising instructions which, when loaded on a computing device, cause the computing device to execute one or more of the methods for storing and retrieving geographic data comprised in a tile pyramid of a multi-level tiled map and/or one or more of the methods for storing and retrieving geographic data comprised in a multi-level tiled map.

### BACKGROUND

The invention can for example be applied in a Geographic Information System (GIS). A Geographic Information System is a computer system for capturing, storing, checking, and displaying data related to geographic positions, i.e., geographic data, wherein for example the geographic data relates to positions on the Earth's surface. A Geographic Information System typically comprises a database used to store the geographic data, and allows for a user to request the geographic data relating to a particular location or locations, and/or store geographic data relating a particular location or locations. The geographic data for example represents a map, for example a map of the world, or a map of a country, or a map of a building layout. Thus, the map is built up of the geographic data stored in the Geographic Information System. Optionally, the Geographic Information System stores geographic data related to a plurality of such maps.

The map represented by the geographic data has a coordinate system. For example, for a 2d-map, the coordinate system defines (x, y) coordinate wherein for example the top-left corner of the map is (0, 0) and the bottom-right corner of the map is (W, H), wherein W is the width of the map and H is the height of the map. The width and the height of the map are for example expressed in meters, or centimeters. Alternatively, the map has an n-dimensional coordinate system, wherein n>2.

Geographic data can for example be raster data, also called raster graphics. Raster data represents an image as an n-dimensional grid of data points. Typically, n is 2 or 3, wherein the raster data thus represents a 2-dimensional or 3-dimensional image. The data points within the grid of the raster data are typically pixels, wherein the pixels contain information on properties of the data point, for example the color of the data point, or a measurement value related to the data point. For example, the pixel is coded according to a particular color model, for example the pixel is represented in the RGB color model or the CMY(K) color model. An advantage of raster data is that there is a simple transformation between an image taken for example by a satellite or a camera and the raster data representing that image. Thus, real-life data is typically represented using raster data.

Raster data representing raster images is typically organized in user-defined layers. Layers can be turned on or off by the user, wherein the images within a layer that is turned on are displayed and images within a layer that is turned off are not displayed.

In real-world applications, where the Geographic Information System is used to store geographic data of a large area, for example of the whole world, a user typically is interested only in a small region comprised in the large area. In such a case, the user requests the Geographic Information System to display the small region. Thereby, the region which the user requests the Geographic Information System to display is also called a viewport. The viewport defines the boundaries of the area that the user wishes to view, wherein the viewport is typically expressed in the coordinate system of the map, for example as a rectangle or a square. One of the capabilities of the Geographic Information System is to only return the data that is relevant to the viewport defined by the user, i.e., the raster data that is contained in and/or intersects with the viewport. Additionally, a zoom level can be determined for the viewport. The zoom level is related to the amount of detail that the user is interested in. For example, if the user is interested in data pertaining to the whole world, the zoom level is coarse such that the data may fit within the viewport. The viewport itself is constrained by the viewing device, such as a screen, that the user is using to view the geographic data. When viewing geographic data related to the whole world or a large portion of the world on a typical computer screen, the geographic data must be scaled down many times before it can fit on the viewport, and thereby fit within the screen. Such scaling down of the geographic data may for example mean that the raster data is sampled. For another example, if the user is interested in data pertaining to a city, then a more fine-grained zoom level (i.e., a higher zoom level) is determined for the viewport. This means that certain information pertaining to certain other cities or countries will not be shown within the viewport. Thus, the Geographic Information System must in that instance only return the geographic data that is relevant to the particular city that the user is interested in.

A Geographic Information System typically allows the user to zoom in or out at will, thereby changing the zoom level, as well as move around, thereby changing the viewport. At a map scale of about 1:70 of a world map (thus, 1 meter on the map is scaled to 1/70 meter, or approximately 1.43 centimeter), a resolution of about 1-2 cm per pixel is required at a display screen sharpness of 96 dpi, which means that the width and the height of raster data is in excess of 2 billion pixels. Thus, the total pixels stored for this map is in excess of 4×10¹⁸ pixels, which represents several exabytes of uncompressed data. To provide sufficient flexibility to the user for zooming into and out of areas, a map scale is necessary that provides sufficient details at higher zoom levels. This, however, has the downside of also loading all details that may not be visible at lower zoom levels. For example, it is not necessary to load all details relating to houses when viewing a map of the whole world. Another downside is that geographic data, such as raster data, is loaded from areas outside of the viewport of the user. In the state of the art, solutions for these two downsides have been developed.

Commonly, a map is divided into tiles to form a tiled map. For example, each tile has a fixed width and height, for example 128×128 pixels or 256×256 pixels or 512×512 pixels. Historically, a tile size of 256×256 pixels is most common. Thus, at a map scale of about 1:70 of a world map, with a tile size of 256×256 pixels, there are around 2×10¹³ tiles. When viewing an area of the world map through a viewport, it is possible to calculate which tiles intersect with the viewport. Instead of loading the whole world map, only those tiles within the viewport are loaded. By loading a tile, the geographic data that is contained within the tile is loaded. This geographic data for example includes raster data. In a typical viewport, only about 10-100 tiles are loaded at any point in time. Therefore, the amount of data that needs to be loaded is significantly reduced.

Each tile has coordinates within a tile coordinate system of the multi-level tiled map. For a 2-dimensional image, tiles are organized in a 2-dimensional tile coordinate system, wherein each tile has an (x, y)-coordinate pair. For a three-dimensional image, tiles are organized in a 3-dimensional tile coordinate system, wherein each tile has an (x, y, z)-coordinate triple. In this example, tiles are organized in a 2-dimensional tile coordinate system, wherein each tile has an (x, y)-coordinate pair. For example, if the multi-level tiled map is divided into 4 tiles, the 4 tiles have coordinates t(0, 0), t(1, 0), t(0, 1), and t(1, 1) respectively, wherein the “t” in front of the coordinate pair indicates that the coordinate pair is expressed in the tile coordinate system. For another example, if the multi-level tiled map is divided into 16 tiles, the 16 tiles have coordinates t(i, j), wherein 0<=i<=15 and 0<=j<=15. Each tile is further associated with a range of coordinates in the coordinate system of the map. For example, if the coordinate system of the map has a top-left corner (0, 0) and a bottom-right corner (15999, 15999), and the multi-level tiled map is divided into 4 tiles, the tile in the top-left corner t(0, 0) is associated with a top-left corner at coordinate (0, 0) and a bottom-right corner at (7999, 7999). Similarly, the tile in the bottom-left corner t(0, 1) is associated with a top-left corner at coordinate (0, 8000) and a bottom-right corner at coordinate (7999, 15999).

Additionally, commonly, tiles are created at a number of predefined zoom levels, thereby forming a multi-level tiled map. For example, at zoom level 0, which represents the most coarse zoom level, there is only one tile. This tile may contain the whole map represented by the raster data at a course detail level. Higher zoom levels progressively comprise more tiles. Lower zoom levels thus are “higher” in the tile pyramid: zoom level 0 is at the “top” of the tile pyramid, while higher zoom levels (zoom levels 1, 2, 3, . . . ) are “below” in the tile pyramid. Another way of referring to the lowest zoom level is as the “first” zoom level and to the highest zoom level as the “last” zoom level. For example, at zoom level 1, there are 4 tiles, wherein each tile contains the data at a finer detail level than the tile at zoom level 0 of a particular area of the map. Typically, at zoom level n there are 4ⁿ tiles. Thus, when the user zooms in or out of the map, a zoom level is calculated and the tiles at that zoom level intersecting with the viewport of the user are returned and displayed. This techniques is generally known as tile pyramids for geographic data or pyramid representation of an image. In this patent application, techniques are described for tile pyramids wherein the tiles on each zoom level are organized in a 2-dimensional tile coordinate system. However, the same techniques are applicable to pyramids wherein the tiles on each zoom level are organized in a tile coordinate system with more dimensions, i.e., for example in a 3-dimensional coordinate system or a 4-dimensional coordinate system, or in general in an n-dimensional coordinate system.

To use the multi-level tiled map, i.e., for example to view the multi-level tiled map, the multi-level tiled map has to be stored on a computer, for example in volatile memory such as in RAM, or on a non-volatile computer medium such as a hard drive or a CD-ROM. By storing the multi-level tiled map in a single file, such a single file would become too large to handle efficiently by the medium on which it is stored. This can lead to issues wherein memory of the computer medium is exhausted. However, if the multi-level tiled map is stored in multiple files, a remaining issue is that the correct file has to be found for retrieving a tile of the multi-level tiled map, which potentially requires to read many files, which requires many slow file accesses. Alternatively or additionally, the correct location within the file has to be found to read the geographic data of the tile once the file has been located. Thus, by splitting up the multi-level tiled map into a plurality of files can result in slow access times when retrieving the geographic data of a tile of the multi-level tiled map.

Current data structures for storing geographic data of a multi-level tiled map require to read the complete header of the data structure to locate the geographic data associated with a particular tile. Thus, read access times of current data structures are slow. Further, current data structures storing all geographic data associated with the multi-level tiled map in a single data structure results in a large single data structure that, for large multi-level tiled maps, cannot be stored in-memory and/or in a single file. Splitting existing data structure into multiple data structures leads to slow read access times since it is required to read the complete header of the data structures to locate the geographic data associated with a particular tile.

### SUMMARY OF THE INVENTION

It is an object of the invention to provide for an improved computer-implemented data structure for storing and retrieving geographic data comprised in a tile pyramid of a multi-level tiled map or for storing and retrieving geographic data comprised in a multi-level tiled map and/or to provide an alternative for the state of the art to overcome some or all of the problems faced in the state of the art. It is further an object of the invention to provide for computer-readable storage media storing geographic data comprised in a tile pyramid of a multi-level tiled map and to computer-readable storage media storing geographic data comprised in a multi-level tiled map, i.e., wherein the computer-readable storage media store geographic data in a data structure for storing and retrieving geographic data comprised in a tile pyramid of a multi-level tiled map or for storing and retrieving geographic data comprised in a multi-level tiled map. It is further an objection of the invention to provide for methods for storing and retrieving geographic data comprised in a tile pyramid of a multi-level tiled map and to methods for storing and retrieving geographic data comprised in a multi-level tiled map, wherein the methods use the data structure for storing and retrieving geographic data comprised in a tile pyramid of a multi-level tiled map or for storing and retrieving geographic data comprised in a multi-level tiled map and/or the computer-readable storage media storing geographic data comprised in a tile pyramid of a multi-level tiled map and/or the computer-readable storage media storing geographic data comprised in a multi-level tiled map. It is further an object of the invention to provide for a computer program comprising instructions which, when loaded on a computing device, cause the computing device to execute one or more of the methods for storing and retrieving geographic data comprised in a tile pyramid of a multi-level tiled map and/or one or more of the methods for storing and retrieving geographic data comprised in a multi-level tiled map.

In a first aspect, the invention pertains to a computer-implemented data structure for storing and retrieving geographic data organized in a tile pyramid of a multi-level tiled map, the multi-level tiled map having a total number of zoom levels zₜₒₜₐₗ, the computer-implemented data structure comprising:
geographic data comprising geographic tile data associated with a tile of the tile pyramid of the multi-level tiled map;
geographic metadata comprising a data pointer to a data location, within the geographic data, of the geographic tile data associated with the tile of the tile pyramid of the multi-level tiled map;

wherein:
coordinates of the tile of the tile pyramid of the multi-level tiled map in a tile coordinate system of the tile pyramid of the multi-level tiled map define a metadata location, within the geographic metadata, of the data pointer to the data location of the geographic tile data associated with the tile of the tile pyramid of the multi-level tiled map.

The data structure according to the first aspect of the invention is usable to store geographic data organized in a tile pyramid of a multi-level tiled map. Such geographic data is technical data usable by a computer-implemented system, for example a Geographic Information System (GIS), to allow users to create, update, and retrieve multi-level tiled maps comprising geographic data of an area of interest, for example a country or the world. The multi-level tiled map comprises a plurality of zoom levels, for example 2 or 8 or 16 or 23 zoom levels. Each zoom level comprises one or more tiles. For example, each zoom level i, with i ranging from 0 to one less than the number of zoom levels, comprises 4ⁱ tiles. So, in a case where the multi-level tiled map comprises 23 levels, the first zoom level (i.e., the least fine-grained zoom level, in other words, the lowest zoom level) comprises 1 tile and the last zoom level (i.e., the most fine-grained zoom level, in other words, the highest zoom level) comprises 4²² tiles. The number of zoom levels comprised in the multi-level tiled map is known as the total number of zoom levels zₜₒₜₐₗ.

For example, the geographic data is raster data, which is an n-dimensional grid of data points, wherein n is for example 2.

Tiles are associated with geographic data relating to rectangular, preferably square, preferably equally-sized, areas of the multi-level tiled map. For example, the multi-level tiled map comprises geographic data related to a map of 2000 km by 2000 km. Then, each tile on a zoom level comprising 16 tiles (zoom level 3) is associated with geographic data of a respective area of the map, wherein each area is 125 km by 125 km. Thus, in other words, each tile is associated with a subset of the geographic data of the map. In a case that the geographic data is raster data, each tile corresponds to an n-dimensional grid of data points, which corresponds to some or all of the data points within an area of the full map. Each tile is associated with geographic data. The geographic data associated with the tile is known as geographic tile data. For example, the geographic tile data associated with each tile are measurement values, such as temperature or humidity or population density of a respective area of the multi-level map. Typically, each tile, irrespective of the zoom level of the multi-level map that comprises the tile, has an equal tile size. The most common tile size is 256×256 pixels. Thus, each tile may comprise geographic data related to 2¹⁶ locations (i.e. pixel values). Depending on the zoom level of the tile, each pixel value in the tile may represent a large area of the underlying map. For example, with a total map size of 2000 km by 2000 km, each pixel in the single tile at zoom level 0 represents an area of around 7.8 km², while a pixel in each tile at zoom level 20 represents an area of around 1.5 m². Thus, the geographic data of higher zoom levels may be aggregated at lower zoom levels. In other words, a higher zoom level is a more fine-grained zoom level, since the tiles in the higher zoom level are associated with a smaller area of the map. Thus, a lower zoom level is a less fine-grained zoom level, since the tiles in the lower zoom level are associated with a larger area of the map.

A multi-level tiled map comprises a top-level tile: this top-level tile is the single tile of the lowest zoom level of the multi-level tiled map. In other words, the top-level tile of the multi-level tiled map is the single tile at the “top” of the multi-level tiled map when viewing the multi-level tiled map as a pyramid, wherein the apex of the pyramid is the top-level tile of the multi-level tiled map. A multi-level tiled map comprises a plurality of bottom-level tiles: these bottom-level tiles of the multi-level tiled map are the tiles of the highest zoom level of the multi-level tiled map. In other words, the bottom-level tiles of the multi-level tiled map are the tiles at the “bottom” of the multi-level tiled map when viewing the multi-level tiled map as a pyramid, wherein the base of the pyramid comprises the bottom-level tiles of the multi-level tiled map. Thus, the top-level tile of the multi-level tiled map is the tile at the lowest zoom level of the multi-level tiled map. The bottom-level tiles of the multi-level tiled map are the tiles at the highest zoom level of the multi-level tiled map.

Similarly, the tile pyramid of the multi-level tile map comprises a top-level tile: this top-level tile is the single tile of the lowest zoom level of the tile pyramid. In other words, the top-level tile of the tile pyramid is the single tile at the “top” of the tile pyramid, wherein the apex of the tile pyramid is the top-level tile of the tile pyramid. A tile pyramid comprises a plurality of bottom-level tiles: these bottom-level tiles are the tiles of the highest zoom level of tile pyramid. In other words, the bottom-level tiles of the tile pyramid are the tiles at the “bottom” of the tile pyramid, wherein the base of the tile pyramid comprises the bottom-level tiles. Thus, the top-level tile of the tile pyramid is the tile at the lowest zoom level of the tile pyramid. The bottom-level tiles of the tile pyramid are the tiles at the highest zoom level of the tile pyramid.

Each tile has coordinates within a tile coordinate system of the multi-level tiled map. The coordinates are a triple (x, y, z) wherein z is the zoom level that comprises the tile, x is the x-coordinate of the tile within the zoom level that comprises the tile, and y is the y-coordinate of the tile within the zoom level that comprises the tile. As already stated, each zoom level typically comprises 4 tiles, i.e., comprises a grid of 2ⁱ by 2ⁱ tiles. Thus, on a zoom level i, 0≤x<2ⁱ and 0≤y<2ⁱ Within this document, the x-coordinate, the y-coordinate, and the zoom level are described as starting at 0. However, it is equally possible that the x-coordinate, the y-coordinate, and the zoom level start at 1. The mathematical formulae within this document are trivially adaptable to a case wherein the x-coordinate, the y-coordinate, and the zoom level start at 1 instead of at 0.

When zooming into a multi-level tiled map, the zoom level increases, i.e., increases from 0 to 1 to 2 etc. One way of looking at a multi-level tiled map is as a tile pyramid, wherein each level of the tile pyramid corresponds to a zoom level of the multi-level tiled map. The apex of the tile pyramid corresponds to zoom level 0, and the base of the tile pyramid corresponds to the highest zoom level, for example zoom level 23. It may further be stated that each tile on a particular zoom level corresponds to 4 tiles on the zoom level directly “below” the particular zoom level within the tile pyramid. In other words, a tile on a particular zoom level i corresponds to 4 tiles on zoom level i+1. Thus, the single tile om zoom level 0 corresponds to the 4 tiles on zoom level 1, the top-left tile of zoom level 1 (i.e., the tile with coordinates (0, 0, 1) corresponds to the top-left 4 tiles of zoom level 2 (i.e., tiles with coordinates (0, 0, 2), (1, 0, 2), (0, 1, 2), (1, 1, 2)), etc. In this context, a tile on a zoom level corresponding to multiple tiles on a higher zoom level (with the higher zoom level being a zoom level “below” the zoom level within the tile pyramid) means that the tile comprises geographic data related to the same equally-sized area of the multi-level tiled map as the multiple tiles on the higher zoom level.

The tiles of a multi-level tiled map can also be organized in multiple tile pyramids, i.e., wherein the multiple tile pyramids are sub-pyramids of the tile pyramid comprising all tiles of the multi-level tiled map. For example, the sub-pyramids may all start at a single zoom level z_{pyramid} of the multi-level tiled map, which means the top-level tile of the sub-pyramid is a tile at zoom level z_{pyramid} of the multi-level tiled map. The sub-pyramids for example comprise tiles on a number of higher zoom levels, i.e., each tile pyramid has at its highest zoom level a subset of the tiles at a higher zoom level z_{pyramid} end of the multi-level tiled map. The sub-pyramids in this example have a height of z_{pyramid_end}−z_{pyramid}, the height of a sub-pyramid being its total number of zoom levels. For example, if z_{pyramid_end}=23 and z_{pyramid}=18, then the height of each sub-pyramid is 5. In this example, the top-level of each sub-pyramid comprises exactly one tile of the multi-level tiled map at zoom level z_{pyramid} of the multi-level tiled map. The bottom level of each sub-pyramid in this example comprises 44=256 tiles of the multi-level tiled map at zoom level z_{pyramid} end of the multi-level tiled map. The top level of each sub-pyramid may also be referred to as a “local” zoom level 0 and the bottom level of each sub-pyramid may also be referred to as a “local” zoom level 4 in this example. Tiles in a sub-pyramid have “local” coordinates in a tile coordinate system of the tile pyramid of the multi-level tiled map. At the same time, tiles have “global” coordinates in a tile coordinate system of the multi-level tiled map. So for example, a tile with global coordinates t(2, 0, 19) has local coordinates t(0, 0, 1) within a (sub-) tile pyramid which has the tile with global coordinates t(1, 0, 18) as its top-level tile.

When referring to “a tile pyramid of a multi-level tiled map”, the tile pyramid may refer to either the “complete” tile pyramid comprising all tiles of the multi-level tiled map, or to a sub-pyramid of the multi-level tiled map. When referring to “coordinates of a tile of a tile pyramid of a multi-level tiled map”, the coordinates refer to local coordinates of the tile within the (sub-) tile pyramid of the multi-level tiled map. i.e., to “local” coordinates of the tile within a tile coordinate system of the (sub-) tile pyramid of the multi-level tiled map. When referring to “coordinates of a tile of a multi-level tiled map”, the coordinates refer to coordinates of the tile within the tile pyramid of the whole multi-level tiled map, i.e., to “global” coordinates of the tile within the tile coordinate system of the multi-level tiled map.

The geographic data organized in the tile pyramid of the multi-level tiled map is comprised in the data structure according to the first aspect of the invention. In other words, the data structure according to the first aspect of the invention is usable to store the geographic tile data associated with one or more tiles of the tile pyramid of the multi-level tiled map. This geographic tile data (and, by extension, the geographic data of the data structure) is for example stored as a series of bytes. To retrieve the geographic data associated with the one or more tiles of the tile pyramid of the multi-level tiled map then means to retrieve the series of bytes.

To retrieve the geographic data that is associated to each tile of the tile pyramid of which the geographic tile data is comprised in the geographic data of the data structure, the data structure comprises geographic metadata. The geographic metadata comprises, for each tile of the tile pyramid of which the geographic tile data is comprised in the geographic data of the data structure, a respective data pointer to a respective data location within the geographic data. Each respective data location is associated with geographic tile data associated with a respective tile of the tile pyramid of the multi-level tiled map. In other words, the data pointer is usable to retrieve the series of bytes that stores the geographic tile data associated with a respective tile of the tile pyramid of the multi-level tiled map.

The coordinates of the tile of the tile pyramid of the multi-level tiled map define a metadata location. In other words, starting from “local” coordinates (x, y, z) of the tile of the tile pyramid of the multi-level tiled map, a metadata location can immediately be derived on which the data pointer to the data location of the geographic tile data associated with the tile of the tile pyramid of the multi-level tiled map can be found. In an example, the data pointers comprised in the geographic metadata are equal-sized, i.e., all data pointers have the same number of bytes. In this example, the geographic metadata can be seen as a sequence of data pointers. Then, the local coordinates (x, y, z) can function as an “access key” defining a sequence number of the data pointer to the data location, within the geographic data, of the geographic tile data associated with the tile of the tile pyramid of the multi-level tiled map. Thus, to retrieve the geographic tile data associated with the tile of the tile pyramid of the multi-level tiled map, the metadata location of the data pointer to the data location of the geographic tile data associated with the tile of the tile pyramid of the multi-level tiled map can directly be found.

Based on the data location, the geographic tile data associated with the tile of the tile pyramid of the multi-level tiled map can be retrieved from the geographic data comprised in the computer-implemented data structure. Therefore, to retrieve the geographic tile data associated with the tile of the tile pyramid of the multi-level map requires only two read operations. There is no need to “search” the data structure for the correct location of the geographic tile data, instead because of the way that the data structure is constructed, the geographic tile data can be readily accessed based on the coordinates of the tile of the tile pyramid of the multi-level tiled map in the tile coordinate system of the tile pyramid of the multi-level tiled map.

In an embodiment according to the first aspect of the invention, the computer-implemented data structure is read-only. Thus, in other words, the geographic data and the geographic metadata of the computer-implemented data structure are constructed only once. In still other words, in this embodiment, the computer-implemented data structure is read-only after storing the geographic data organized in the tile pyramid of the multi-level tiled map. The geographic data and the geographic metadata of the computer-implemented data structure are constructed based on the geographic data organized in the tile pyramid of the multi-level tiled map. Once the data structure has been created, the data structure can no longer be modified. In this embodiment, it can be assumed that the size of the data structure remains constant and that no additional geographic tile data will have to be appended after the computer-implemented data structure is created, and/or that geographic tile data will have to be removed after the computer-implemented data structure is created. Thus, the way that the coordinates of the tile of the tile pyramid of the multi-level tiled map in the tile coordinate system of the tile pyramid of the multi-level tiled map define the metadata location, within the geographic metadata, of the data pointer to the data location of the geographic tile data associated with the tile of the tile pyramid of the multi-level tiled map remains constant.

In an embodiment according to the first aspect of the invention, the geographic metadata is comprised in a header of the computer-implemented data structure. The header of the computer-implemented data structure is located at the “front” of the data structure, i.e., when reading the data structure as a sequence of bytes, the header is represented by a first subsequence of bytes within the sequence of bytes. Thus, when reading the data structure, the metadata is the first element of the data structure that is encountered. When the geographic tile data associated with the tile of the tile pyramid of the multi-level tiled map is to be located, this embodiment enables to first read the data pointer to the data location of the geographic tile data associated with the tile of the tile pyramid of the multi-level tiled map from the geographic metadata. Then, based on the data pointer, this embodiment enables to jump ahead to the data location of the geographic tile data, within the geographic data, associated with the tile of the tile pyramid of the multi-level tiled map. Thus, the byte sequence representing the data structure is read sequentially and the number of read accesses is reduced to two. This increases read performance in comparison to a case whereby the geographic metadata would instead be stored “behind” the geographic data within the data structure. By comprising the geographic metadata in a header of the computer-implemented data structure, read access time is reduced.

In an embodiment according to the first aspect of the invention, the data pointer comprises a start memory address offset and an end memory address offset. In a variant of this embodiment, the data pointer has a fixed size, for example wherein the fixed size is 16 bytes. In this variant of the embodiment, the start memory address offset and the end memory address offset have a fixed equal size, for example wherein the fixed equal size is 8 bytes.

The geographic tile data associated with the tile of the tile pyramid of the multi-level tiled map is an uninterrupted sequence of bytes. The start memory address offset is a numeric value that refers to a location within the geographic data of the computer-implemented data structure at which the geographic tile data associated with the tile of the tile pyramid of the multi-level tiled map begins. In other words, the start memory address offset points to the start of the uninterrupted sequence of bytes. The end memory address offset is a numeric value that refers to a location within the geographic data of the computer-implemented data structure at which the geographic tile data associated with the tile of the tile pyramid of the multi-level tiled map ends. In other words, the end memory address offset points to the end of the uninterrupted sequence of bytes. The start memory address offset and the end memory address offset are for example relative to the start memory address of the computer-implemented data structure, or relative to the metadata location, or they are absolute memory addresses.

By storing, as part of the data pointer, the start memory address offset and the end memory address offset, read operations are efficiently implemented. The start memory address offset and the end memory address offset are used during a read operation to find the start and the end of the sequence of bytes representing the geographic tile data associated with the tile of the tile pyramid of the multi-level tiled map. Thus, a read operation uses the start memory address offset and the end memory address offset to efficiently locate and read the sequence of bytes representing the geographic tile data associated with the tile of the tile pyramid of the multi-level tiled map.

In an example embodiment according to the first aspect of the invention, the computer-implemented data structure is read-only, the geographic metadata is comprised in a header of the computer-implemented data structure, the data pointer comprises a start memory address offset and an end memory address offset, the data pointer has a fixed size, for example wherein the fixed size is 16 bytes, and the start memory address offset and the end memory address offset have a fixed equal size, for example wherein the fixed equal size is 8 bytes.

In this example embodiment, coordinates of a tile of the tile pyramid of the multi-level map to be retrieved are for example (x, y, z). These coordinates are used as an “access key” that define a metadata location of the data pointer to the data location of the geographic tile data associated with the tile of the tile pyramid of the multi-level tiled map. Since the data pointers comprised in the geographic metadata have a fixed size, it is known from the coordinates which bytes to read from the header. For example, the first data pointer comprised in the geographic metadata (i.e., the header) is located between bytes [0, 15] of the geographic metadata and points to the geographic tile data associated with a tile with coordinates (0, 0, 1). The first data pointer comprised in the geographic metadata (i.e., the header) is located between bytes [16, 31] of the geographic metadata and points to the geographic tile data associated with a tile with coordinates (1, 0, 1). Thus, starting from the coordinates of the tile for which to retrieve the geographic tile data, the data pointer to the geographic tile data of that tile can be retrieved from the geographic metadata comprised in the computer-implemented data structure with a single read operation, since the start and end byte of the data pointer are known from the coordinates.

In this example embodiment, because the geographic metadata is comprised in the header of the computer-implemented data structure, only one read operation is necessary: if it were stored at the footer (i.e., the end) of the data structure, then a search for the start of the geographic metadata would be required before being able to retrieve the data pointer from the geographic metadata. It is possible to store the geographic metadata in the header of the computer-implemented data structure because the computer-implemented data structure in this example embodiment is read-only. Therefore, once the geographic data of a tile pyramid of a multi-level map is stored in the computer-implemented data structure, no data will be added or removed from the computer-implemented data structure which ensures that no reorganization of the data will be necessary because of the geographic metadata being stored in the header of the computer-implemented data structure.

In an embodiment according to the first aspect of the invention, the tile pyramid comprises all tiles of i zoom levels of the multi-level tiled map, preferably the last i zoom levels of the multi-level tiled map, wherein i is an integer, wherein 0<i<=zₜₒₜₐₗ, wherein zₜₒₜₐₗ is the total number of zoom levels of the multi-level tiled map, for example wherein i is 5. For example, the sub-pyramids may all start at a single zoom level z_{pyramid} of the multi-level tiled map, which means the top-level tile of each sub-pyramid is a respective tile at zoom level z_{pyramid} of the multi-level tiled map. The sub-pyramids for example comprise the tiles of all higher zoom levels, i.e., each tile pyramid has at its highest zoom level a subset of the tiles at zoom level zₜₒₜₐₗ Of the multi-level tiled map. The sub-pyramids in this example have a height of zₜₒₜₐₗ−z_{pyramid}, the height of a sub-pyramid being its total number of zoom levels. For example, if zₜₒₜₐₗ=23 and z_{pyramid}=18, then the height of each sub-pyramid is 5. In this example, the top-level of each sub-pyramid comprises exactly one tile of the multi-level tiled map at zoom level z_{pyramid} of the multi-level tiled map. The bottom level of each sub-pyramid in this example comprises 44=256 tiles of the multi-level tiled map at zoom level zₜₒₜₐₗ of the multi-level tiled map. The top level of each sub-pyramid may also be referred to as a “local” zoom level 0 and the bottom level of each sub-pyramid may also be referred to as a “local” zoom level 4 in this example. In this example, there are 4¹⁸ (sub-) tile pyramids of the multi-level tiled map.

In an embodiment according to the first aspect of the invention, the geographic data comprises geographic tile data associated with all tiles of the tile pyramid of the multi-level tiled map. In this embodiment, the geographic metadata comprises, for all tiles of the tile pyramids of the multi-level tiled map, a respective data pointer to a respective data location of geographic tile data associated with a respective tile of the tile pyramid of the multi-level tiled map. In this embodiment, the data pointers comprised in the geographic metadata are sorted based on coordinates, in the tile coordinate system of the tile pyramid of the multi-level tiled map, of the tiles of the tile pyramid of the multi-level tiled map, the coordinates of the tiles of the tile pyramid of the multi-level tiled map defining, within the geographic metadata, the metadata locations of the data pointers to the data locations of the geographic tile data associated with each respective tile of the tile pyramid of the multi-level tiled map. Preferably, also the geographic data of the computer-implemented data structure is sorted based on the coordinates, in the tile coordinate system of the tile pyramid of the multi-level tiled map, of the tiles of the tile pyramid of the multi-level tiled map.

In a variant of this embodiment, the data pointers comprised in the geographic metadata are sorted based on the coordinates (z, y, x), wherein z is the zoom level of each respective tile in the tile pyramid, y is the y-coordinate of each respective tile in the tile pyramid on the zoom level z, wherein 0<=y<2^{z}, and x is the x-coordinate of each respective tile in the tile pyramid on the zoom level z, wherein 0<=x<2^{z}.

In a further variant of this embodiment, the tile pyramid comprises all tiles of i zoom levels of the multi-level tiled map, preferably the last i zoom levels of the multi-level tiled map, wherein i is an integer, wherein 0<i<=zₜₒₜₐₗ, for example wherein i is 5, 0<=z<i.

In a further variant of this embodiment, the metadata location is defined based on a sequence number seq, the sequence number seq being defined as

$${\sum }_{i = 0}^{z - 1} {4}^{i} + ( y * {2}^{z} ) + x$$

if z>0 and the sequence number seq being defined as 0 if z=0.

In this embodiment and its variants, geographic data associated with all tiles of the tile pyramid of the multi-level tiled map is comprised within the geographic data of the computer-implemented data structure. To efficiently locate the geographic tile data associated with a particular tile of the tile pyramid of the multi-level tiled map, the data pointers comprised in the geographic metadata are sorted based on the coordinates of the tiles of the tile pyramid of the multi-level tiled map. In other words, the data pointers comprised in the geographic metadata are stored in the geographic metadata are in a predefined order. Since this order is predefined, and based on the coordinates of the tiles of the tile pyramid of the multi-level tiled map, the geographic metadata can be efficiently accessed to retrieve a data pointer to a data location, within the geographic data, of the geographic tile data associated with a particular tile of the tile pyramid of the multi-level tiled map. For example, the data pointers comprised in the geographic metadata are sorted based on the coordinates (z, y, x). Then, to retrieve the data pointer to a data location, within the geographic data, of the geographic tile data associated with a tile of the tile pyramid of the multi-level tiled map with coordinates (x, y, z)=(1, 2, 2), it is deduced that a sequence number of the data pointer within the geographic metadata is (1+4)+8+1=14. This is because there is 1 data pointer for a tile at zoom level 0, 4 data pointers for tiles at zoom level 1, 8 data pointers for tiles at zoom level 2 which have a y-value smaller than 2 (i.e., 4 tiles at zoom level 2 with a y-value of 0 and 4 tiles at zoom level 1 with a y-value of 1), and 1 data pointer for a tile at zoom level 2 with y-value 2 with an x-value smaller than 1 (i.e., 1 tile at zoom level 2 with a y-value of 2 and an x-value of 0). Thus, the coordinates (1, 2, 2) define a sequence number 14 of the data pointer within the geographic metadata. From the sequence number, the metadata location of the data pointer within the geographic metadata is deduced. For example, if each data pointer has a size of 16 bytes, a data pointer with sequence number 14 starts at byte 226 of the geographic metadata.

In a preferential variant of this embodiment, the data pointer comprises a start memory address offset and an end memory address offset. Further, in this preferential variant, the data pointer has a fixed size, for example wherein the fixed size is 16 bytes and the start memory address offset and the end memory address offset have a fixed equal size, for example wherein the fixed equal size is 8 bytes. Once the sequence number of the data pointer within the geographic metadata is determined, for example to be 14 as in the example above, then the memory address of the data pointer, relative to the start memory address of the computer-implemented data structure, can be computed as 14*16=224. So, to retrieve the data pointer of the tile of the tile pyramid of the multi-level tiled map with coordinates (1, 2, 2), the 224th byte until the 240th byte of the geographic metadata needs to be read.

The skilled person understands that the data pointers within the geographic metadata can be sorted based on any permutation of the coordinates of the tiles, for example based on (x, y, z) or (y, x, z), and the formula to define the sequence number of the data pointer of a particular tile is trivially adapted to such a sorting scheme. Further, it is understood by the skilled person that the coordinate system of the tile pyramid of the multi-level tiled map is not necessarily 0-based, but can for example also be 1-based, and in such cases the formulate to define the sequence number of the data pointer of a particular tile is trivially adapted.

In a second aspect, the invention pertains to a computer-readable storage medium storing, in a computer-implemented data structure according to the first aspect of the invention, geographic data organized in the tile pyramid of the multi-level tiled map.

The computer-readable storage medium is for example volatile random-access memory (RAM) or non-volatile storage such as a hard disk or a USB stick. The computer-implemented data structure according to the first aspect of the invention is a sequence of bytes that is stored on such a computer-readable storage medium.

In a third aspect, the invention pertains to computer-implemented data structure collection for storing and retrieving geographic data of a multi-level tiled map comprising a plurality of tile pyramids, the computer-implemented data structure collection comprising a plurality of computer-implemented data structures according to the first aspect of the invention.

Each computer-implemented data structure is suitable for storing and retrieving geographic data organized in a respective tile pyramid, wherein the respective tile pyramid comprises, as its top-level tile, a respective tile of the multi-level tiled map. A single zoom level z_{pyramid} of the multi-level tiled map comprises the top-level tile of all tile pyramids of the multi-level tiled map, wherein 0<z_{pyramid}<zₜₒₜₐₗ. A triple formed by coordinates of a tile of the multi-level tiled map in the tile coordinate system of the multi-level tiled map, the total number of zoom levels of the multi-level tiled map (zₜₒₜₐₗ), and the single zoom level (z_{pyramid}), define a data structure collection location, within the computer-implemented data structure collection, of the computer-implemented data structure comprising geographic tile data associated with the tile of the multi-level tiled map.

A multi-level tiled map comprises multiple tile pyramids, i.e., sub-pyramids. These sub-pyramids each have a single tile at the single zoom level z_{pyramid} as their top-level tile. In other words, each sub-pyramid “starts” at zoom level z_{pyramid}. Sub-pyramids do not share their top-level tiles, i.e., each sub-pyramid has a unique top-level tile at zoom level z_{pyramid}. So, that means there are exactly 4^{z_pyramid} sub-pyramids.

To store the geographic data of the plurality of tile pyramids, the computer-implemented data structure collection comprising a plurality of computer-implemented data structures according to the first aspect of the invention. Thus, each one of the plurality of computer-implemented data structures is suitable for storing and retrieving geographic data organized in a respective tile pyramid. For example, if there are 85 sub-pyramids of the multi-level tiled map, then there are 85 computer-implemented data structure comprised in the computer-implemented data structure collection.

To retrieve the geographic data associated with a tile of the multi-level tiled map within the computer-implemented data structure collection, the triple ((x, y, z), zₜₒₜₐₗ, z_{pyramid}) define a data structure collection location. This data structure collection location is the location, within the computer-implemented data structure collection, of the computer-implemented data structure comprising geographic tile data associated with the tile of the multi-level tiled map. This is done by first determining a zoom level z_{local} within a tile pyramid of the multi-level tiled map, the zoom level z_{local} comprising the tile of the multi-level tiled map to be retrieved, wherein z_{local}=z−z_{pyramid}. Then, the coordinates of the top-level tile of the tile pyramid at the zoom level z_{pyramid} of the multi-level tiled map are determined as

$$( {x}_{pyramid} , {y}_{pyramid} ) = ( floor ( \frac{x}{{2}^{{z}_{local}}} ) , floor ( \frac{y}{{2}^{{z}_{local}}} ) ) .$$

Thus the coordinates of the tile pyramid (i.e., the sub-pyramid) comprising the tile of the multi-level tiled map is now known as (x_{pyramid}, y_{pyramid}, z_{pyramid}). The computer-implemented data structure collection is for example implemented as a collection of files stored on a non-volatile storage medium, for example a hard disk. In that case, the name of each of the files within the computer-implemented data structure collection is structured according to the coordinates of a respective tile pyramid of the multi-level tiled map. For example, the file names are of the form “pyramid_x_{pyramid}_y_{pyramid}_z_{pyramid}” and they are organized in a single folder. Then, having computed (x_{pyramid}, y_{pyramid}, z_{pyramid}), the computer-implemented data structure comprising the geographic data associated with the tile of the multi-level tiled map can be readily retrieved. From the coordinates of the tile of the multi-level tiled map, coordinates of the tile within the tile pyramid (i.e., “local coordinates”) that comprises the tile of the multi-level tiled map can be readily computed. Then, the geographic tile data associated with the tile of the multi-level tiled map can be readily retrieved from the computer-implemented data structure comprising the geographic data associated with the tile of the multi-level tiled map, which computer-implemented data structure is according to the first aspect of the invention, by using the local coordinates as an access key to the geographic metadata of the computer-implemented data structure comprising the geographic data associated with the tile of the multi-level tiled map.

When compared to known data structures and data structure collections for storing geographic data of a multi-level tiled map, data of a tile in that multi-level tiled map can be retrieved using the data structure collection according to the third aspect of the invention in a fraction of the time that would normally be necessary. When compared to tar archives, data is retrieved 20 times faster from the data structure collection according to the third aspect of the invention. When compared to Cloud Optimized Geotiff archives, data is retrieved 10 times faster from the data structure collection according to the third aspect of the invention.

In a first embodiment according to the third aspect of the invention, the computer-implemented data structure collection further comprises a further computer-implemented data structure according to the first aspect of the invention for storing and retrieving a further tile pyramid comprising, as its top-level tile, a top-level tile of the multi-level tiled map, and comprising, as its bottom-level tiles, all tiles comprised in zoom level z_{pyramid}−1.

Since z_{pyramid}>0, at least one tile of the multi-level map is not comprised in any of the tile pyramids. Typically, z_{pyramid} is quite “low” within the tile pyramid representing the multi-level tiled map. In other words, z_{pyramid} is a relatively high zoom level of the multi-level tiled map. For example, if the multi-level tiled map has 23 zoom levels, z_{pyramid} is 18, which means that each tile pyramid (i.e., each sub-pyramid) has 5 “local” zoom levels. In another example, z_{pyramid} is 19 or 17. In any case, all tiles at zoom levels “above” z_{pyramid} (i.e., zoom levels smaller than z_{pyramid}) are not contained within any of the sub-pyramids. Thus, in this embodiment, the further computer-implemented data structure comprises geographic data associated with the tiles of a sub-pyramid of the multi-level tiled map that has as its top-level tile a top-level tile of the multi-level tiled map, and as its bottom-level tiles, all tiles comprised in a zoom level of the multi-level tiled map that is one less than the single zoom level z_{pyramid}, i.e., z_{pyramid}−1. The zoom level of the multi-level tiled map that is one less than the single zoom level z_{pyramid} is the zoom level directly “above” the single zoom level z_{pyramid}. To compute the zoom level of the multi-level tiled map that is one less than the single zoom level z_{pyramid}, the operation z_{pyramid}−1 is performed.

So for example, if z_{pyramid} is 18, then the zoom level of the multi-level tiled map that is one less than the single zoom level z_{pyramid} is 17, and thus the further computer-implemented data structure comprises geographic data associated with the tiles of the multi-level tiled map at zoom levels 0 through 17. Thus, if the geographic data associated with a tile with a z-coordinate less than 18 is to be retrieved, the data structure collection location is the location of the further computer-implemented data structure.

In a fourth aspect, the invention pertains to a computer-readable storage medium storing, in a computer-implemented data structure collection according to the third aspect of the invention, geographic data comprised in a multi-level tiled map comprising a plurality of tile pyramids.

The computer-implemented data structure collection is for example implemented as a collection of files stored on a non-volatile storage medium, for example a hard disk. In that case, the name of each of the files within the computer-implemented data structure collection is structured according to the coordinates of a respective tile pyramid of the multi-level tiled map. For example, the file names are of the form “pyramid_x_{pyramid}_y_{pyramid}_z_{pyramid}” and they are organized in a single folder. Alternatively, the computer-implemented data structure collection is stored as a sequence of bytes in random-access memory (RAM).

In a fifth aspect, the invention pertains to a computer-implemented method for storing geographic data comprised in a tile pyramid of a multi-level tiled map in a computer-implemented data structure according to the first aspect of the invention or on a computer-readable storage medium according to the second aspect of the invention, the computer-implemented method comprising the step of:
storing, within the geographic data of the computer-implemented data structure, geographic tile data associated with the tiles of the tile pyramid of the multi-level tiled map;
storing, within the geographic metadata of the computer-implemented data structure, data pointers to data locations, within the geographic data, of geographic tile data associated with each respective tile of the tile pyramid of the multi-level tiled map.

The computer-implemented method for storing geographic data comprised in the tile pyramid of the multi-level tiled map is used to efficiently store such geographic data within a computer-implemented data structure or on a computer-readable storage medium. The data layout of the data structure that is stored, and its benefits, is described in the description of the first aspect of the invention.

In a sixth aspect, the invention pertains to a computer-implemented method for retrieving geographic tile data associated with a tile of a tile pyramid of a multi-level tiled map from a computer-implemented data structure according to the first aspect of the invention or from a computer-readable medium according to the second aspect of the invention, the method comprising the steps of:
receiving, in a coordinate system of the tile pyramid of the multi-level tiled map, the coordinates of the tile of the tile pyramid of the multi-level tiled map to be retrieved;
determining a sequence number (seq) based on the coordinates, in the tile coordinate system of the tile pyramid of the multi-level tiled map, of the tile of the tile pyramid of the multi-level tiled map to be retrieved;
retrieving, from a metadata location within the geographic metadata associated with the sequence number (seq) comprised in the computer-implemented data structure storing geographic data of the tile pyramid of the multi-level tiled map, a data pointer to a data location of geographic tile data associated with the tile of the tile pyramid of the multi-level tiled map to be retrieved;
retrieving, from the data location of the geographic tile data associated with the tile of the tile pyramid of the multi-level tiled map to be retrieved within the geographic data of the computer-implemented data structure storing the geographic data of the tile pyramid of the multi-level tiled map, geographic tile data associated with the tile of the tile pyramid of the multi-level tiled map to be retrieved.

Because the coordinates of the tile of the tile pyramid of the multi-level map to be retrieved define a metadata location, within the geographic metadata, of the data pointer to the data location of the geographic tile data associated with the tile of the tile pyramid of the multi-level tiled map, the data pointer can be readily retrieved from the geographic metadata. The data pointer points directly to the geographic tile data associated with the tile of the tile pyramid of the multi-level tiled map. Thus, having retrieved the data pointer from the geographic metadata, the geographic tile data associated with the tile of the tile pyramid of the multi-level tiled map can be readily retrieved.

In an embodiment according to the sixth aspect of the invention the coordinates of the tile of the tile pyramid of the multi-level tiled map to be retrieved are (x, y, z), wherein z is the zoom level of the tile of the tile pyramid, x is the x-coordinate of the tile of the tile pyramid on the zoom level z of the tile pyramid, wherein 0<=x<2^{z} and y is the y-coordinate of the tile of the tile pyramid on the zoom level z, wherein 0<=y<2^{z}. In the step of determining the sequence number (seq), determining the sequence number (seq) as

$$seq = {\sum }_{i = 0}^{z - 1} {4}^{i} + ( y * {2}^{z} ) + x if z > 0 ,$$

and determining the sequence number (seq) as 0 if z=0.

For example, the data pointers comprised in the geographic metadata are sorted based on the coordinates (z, y, x). Then, to retrieve the data pointer to a data location, within the geographic data, of the geographic tile data associated with a tile of the tile pyramid of the multi-level tiled map with coordinates (x, y, z)=(1, 2, 2), it is deduced that a sequence number of the data pointer within the geographic metadata is (1+4)+8+1=14. This is because there is 1 data pointer for a tile at zoom level 0, 4 data pointers for tiles at zoom level 1, 8 data pointers for tiles at zoom level 2 which have a y-value smaller than 2 (i.e., 4 tiles at zoom level 2 with a y-value of 0 and 4 tiles at zoom level 1 with a y-value of 1), and 1 data pointer for a tile at zoom level 2 with y-value 2 with an x-value smaller than 1 (i.e., 1 tile at zoom level 2 with a y-value of 2 and an x-value of 0). Thus, the coordinates (1, 2, 2) define a sequence number 14 of the data pointer within the geographic metadata.

In a preferential variant of this embodiment, the data pointer comprises a start memory address offset and an end memory address offset. Further, in this preferential variant, the data pointer has a fixed size, for example wherein the fixed size is 16 bytes and the start memory address offset and the end memory address offset have a fixed equal size, for example wherein the fixed equal size is 8 bytes. Once the sequence number of the data pointer within the geographic metadata is determined, for example to be 14 as in the example above, then the memory address of the data pointer, relative to the start memory address of the computer-implemented data structure, can be computed as 14*16=224. So, to retrieve the data pointer of the tile of the tile pyramid of the multi-level tiled map with coordinates (1, 2, 2), the 224^{th} byte until the 240^{th} byte of the geographic metadata needs to be read.

The skilled person understands that the data pointers within the geographic metadata can be sorted based on any permutation of the coordinates of the tiles, for example based on (x, y, z) or (y, x, z), and the formula to define the metadata location of the data pointer of a particular tile is trivially adapted to such a sorting scheme. Further, it is understood by the skilled person that the coordinate system of the tile pyramid of the multi-level tiled map is not necessarily 0-based, but can for example also be 1-based, and in such cases the formulate to define the metadata location of the data pointer of a particular tile is trivially adapted.

In a seventh aspect, the invention pertains to a computer-implemented method for storing geographic data comprised in a multi-level tiled map in a computer-implemented data structure collection according to the third aspect of the invention or on a computer-readable storage medium according to the fourth aspect of the invention, wherein the computer-implemented data structure collection comprises a plurality of computer-implemented data structures according to the first aspect of the invention, the computer-implemented method comprising the steps of:
determining the single zoom level (z_{pyramid}) of the multi-level tiled map;
storing, in each computer-implemented data structure of the computer-implemented data structure collection, geographic data comprised in a tile pyramid comprising, as its top-level tile, a respective tile of the multi-level tiled map comprised in the single zoom level (z_{pyramid}) of the multi-level tiled map, and comprising, as its bottom-level tiles, respective tiles of the multi-level tiled map comprised in zoom level zₜₒₜₐₗ−1, wherein zₜₒₜₐₗ is the total number of zoom levels of the multi-level tiled map, using a computer-implemented method according to the fifth aspect of the invention.

The zoom level z_{pyramid} of the multi-level tiled map is determined based on application requirements. For example, this determination is based on the amount of zoom levels of the multi-level tiled map. For example, if the multi-level map comprises 23 zoom levels, z_{pyramid} is determined to be 17 or 18 to have sub-pyramids comprising 6 or 5 zoom-levels, respectively. For another example, if the multi-level map comprises 20 zoom levels, z_{pyramid} is determined to be 16 or 17 to have sub-pyramids comprising 4 or 3 zoom-levels.

Optionally, the computer-implemented data structure collection is a computer-implemented data structure according to the first embodiment according to the third aspect of the invention. In other words, the computer-implemented data structure collection further comprises a further computer-implemented data structure according to the first aspect of the invention for storing and retrieving a further tile pyramid. In this case, the computer-implemented method for storing geographic data comprised in a multi-level tiled map in a computer-implemented data structure collection further comprises the step of:
storing, in the further computer-implemented data structure, geographic data comprised in the further tile pyramid comprising, as its top-level tile, a top-level tile of the multi-level tiled map, and comprising, as its bottom-level tiles, all tiles comprised in zoom level z_{pyramid}−1 of the multi-level tiled map.

If the multi-level map comprises 23 zoom levels and z_{pyramid} is determined to be 17, then the further computer-implemented data structure is suitable for storing geographic data comprised in the further tile pyramid comprising, as its top-level tile, a top-level tile of the multi-level tiled map (i.e., the tile at zoom level 0 of the multi-level tiled map) and as its bottom-level tiles, all tiles comprised in zoom level 16.

In an eighth aspect, the invention pertains to a computer-implemented method for retrieving a tile of a multi-level tiled map from a computer-implemented data structure collection according to the third aspect of the invention or from a computer-readable storage medium according to the fourth aspect of the invention, the method comprising the steps of:
receiving, in a coordinate system of the multi-level tiled map, the coordinates of the tile of the multi-level tiled map to be retrieved;
if it is determined that a zoom level comprising the tile of the multi-level tiled map (zₜᵢₗₑ) is larger than or equal to the single zoom level (z_{pyramid}):
retrieving, from the computer-implemented data structure collection, a computer-implemented data structure storing geographic data of a tile pyramid of the multi-level tiled map comprising the tile of the multi-level tiled map to be retrieved;
determining, in the coordinate system of the tile pyramid of the multi-level tiled map, coordinates of the tile of the tile pyramid of the multi-level tiled map to be retrieved, based on the coordinates, in the coordinate system of the multi-level tiled map, of the tile of the multi-level tiled map to be retrieved;
retrieving geographic tile data associated with the tile of the tile pyramid of the multi-level tiled map using a computer-implemented method according to the sixth aspect of the invention.

To retrieve the tile of the multi-level tiled map from the computer-implemented data structure collection, first it needs to be determined whether the zoom level comprising the tile of the multi-level tiled map zₜᵢₗₑ is part of a sub-pyramid of the multi-level tiled map. For example, if the coordinates of the tile are (x, y, z), then zₜᵢₗₑ=Z, and if z is for example 2, while z_{pyramid} is 18, then the geographic data associated with the tile is not stored within any of the computer-implemented data structures of the computer-implemented data structure collection. However, if zₜᵢₗₑ>z_{pyramid}, then the computer-implemented data structure that comprises the geographic data associated with the tile is determined based on the coordinates, In the coordinate system of the multi-level tiled map, of the tile of the multi-level tiled map to be retrieved. Then, the coordinates of the tile of the tile pyramid of the multi-level tiled map to be retrieved, in the coordinate system of the tile pyramid of the multi-level tiled map, are determined. In other words, the “local” coordinates of the tile in the coordinate system of the tile pyramid are determined based on the “global” coordinates of the tile in the coordinate system of the multi-level tiled map. Once the local coordinates of the tile are determined, the geographic data associated with the tile can be retrieved from the computer-implemented data structure according to the sixth aspect of the invention. In other words, the tile data associated with the tile of the tile pyramid of the multi-level map is retrieved from the computer-implemented data structure storing geographic data of the tile pyramid of the multi-level tiled map comprising the tile of the multi-level tiled map to be retrieved.

In an embodiment according to the eighth aspect of the invention, the computer-implemented data structure collection is a computer-implemented data structure collection according to the first embodiment of the third aspect of the invention.

In this embodiment, the method further comprises the following steps if it is determined that the zoom level comprising the tile of the multi-level tiled map (zₜᵢₗₑ) is smaller than the single zoom level (z_{pyramid}):
determining, in the coordinate system of the further tile pyramid of the multi-level tiled map, coordinates of the tile of the further tile pyramid of the multi-level tiled map, based on the coordinates, in the coordinate system of the multi-level tiled map, of the tile of the multi-level tiled map to be retrieved;
retrieving geographic tile data associated with the tile of the tile pyramid of the multi-level tiled map using a computer-implemented method according to the sixth aspect of the invention.

In this embodiment, if the zoom level comprising the tile of the multi-level tiled map zₜᵢₗₑ<z_{pyramid}, this means that the geographic data associated with the tile is not contained within any of the tile pyramids, but rather is contained in the further tile pyramid of the multi-level tiled map, as described in the description of the first embodiment of the third aspect of the invention. Thus, the geographic tile data associated with the tile of the tile pyramid of the multi-level tiled map is retrieved from the further tile pyramid using a computer-implemented method according to the sixth aspect of the invention.

In an embodiment according to the eighth aspect of the invention, the coordinates of the tile of the multi-level tiled map to be retrieved are (x, y, z), wherein z is the zoom level of the tile of the multi-level tiled map, x is the x-coordinate of the tile of the multi-level tiled map on the zoom level z, wherein 0<=x<2^{z} and y is the y-coordinate of the tile of the multi-level tiled map on the zoom level z, wherein 0<=y<2^{z}.

In this embodiment, in the step of retrieving, from the computer-implemented data structure collection, the computer-implemented data structure storing geographic data of the tile pyramid of the multi-level tiled map comprising the tile of the multi-level tiled map to be retrieved, retrieving the computer-implemented data structure storing geographic data of the tile pyramid having as its top-level tile the tile with coordinates (x_{pyramid}, y_{pyramid}) at zoom level z_{pyramid} of the multi-level tiled map.

z_{pyramid} is the zoom level of the multi-level tiled map that comprises the top-level tiles of the tile pyramids of the multi-level tiled map. In other words, the tile pyramids of the multi-level tiled map “start” at zoom level z_{pyramid}.

In this embodiment, in the step of determining, in the coordinate system of the tile pyramid of the multi-level tiled map, coordinates of the tile of the tile pyramid of the multi-level tiled map, based on the coordinates, in the coordinate system of the multi-level tiled map, of the tile of the multi-level tiled map to be retrieved, the method further comprises the steps of:
determining a zoom level z_{local} within the tile pyramid, the zoom level z_{local} comprising the tile of the multi-level tiled map to be retrieved, wherein z_{local}=Z-z_{pyramid},
determining the coordinates of the top-level tile of the tile pyramid at the zoom level z_{pyramid} of the multi-level tiled map as

$$( {x}_{pyramid} , {y}_{pyramid} ) = ( floor ( \frac{x}{{2}^{{z}_{local}}} ) , floor ( \frac{y}{{2}^{{z}_{local}}} ) ) ;$$

determining the coordinates (x_{local}, y_{local}) of the tile within the tile pyramid as (x_{local}, y_{local})=(x−x_{pyramid}*2^{z}^{_{local}}, y−y_{pyramid}*2^{z}^{_{local}}).

These steps compute, starting from the coordinates (x, y, z) of the tile in the coordinate system of the multi-level tiled map, the coordinates (x_{local}, y_{local}, z_{local}) in the coordinate system of the tile pyramid of the multi-level tiled map. First, local zoom level z_{local} is determined as z_{local}=Z−z_{pyramid}. Since z=zₜᵢₗₑ and zₜᵢₗₑ>z_{pyramid}, z_{local} is a positive number. Basically, the operation substracts the levels of the multi-level tiled map “above” the tile pyramid, leaving only the “remainder” of zoom levels within the tile pyramid. Then, (x_{pyramid}, y_{pyramid}) is computed as

$$( floor ( \frac{x}{{2}^{{z}_{local}}} ) , floor ( \frac{y}{{2}^{{z}_{local}}} ) ) .$$

These coordinates (x_{pyramid}, y_{pyramid}) are the coordinates of the top-level tile within zoom level z_{pyramid} of the multi-level tiled map of the tile pyramid containing the tile. This formula takes into account the fact that there are 2^{z}^{_{local}} tiles within the zoom level z_{local} of each tile pyramid. To know the tile pyramid we need (i.e., to know the top-level tile of the tile pyramid we need), we need to determine which tile pyramid contains that specific tile on zoom level z_{local}. To demonstrate with an example, assume z_{local}=1 and (x, y)=(638, 105). Then, (x_{pyramid}, y_{pyramid})=(319, 52). The tile pyramid will have 4 tiles on zoom level z_{local}=1. We also know that these 4 tiles will be the tiles with x- and y-coordinates (638, 104), (638, 105), (639, 104), and (639, 105) within the coordinate system of the multi-level tiled map. This is because we can place all the tiles in zoom level z_{local} in a grid of all tile pyramids, i.e., the grid formed by all top-level tiles of the tile pyramids. On each zoom level z_{local}, a tile pyramid with top-level tile at (x_{pyramid}, y_{pyramid}) will have tiles (within the coordinate system of the multi-level tiled map) with x-coordinates ranging from x*2^{z}^{_{local}} to x*2^{z}^{_{local}}+2^{z}^{_{local}}−1 and y-coordinates ranging from y*2^{z}^{_{local}} to y*2^{z}^{_{local}}+2^{z}^{_{local}}−1. Finally, (x_{local}, y_{local}) is computed as (x−x_{pyramid}*2^{z}^{_{local}}, y−y_{pyramid}*2^{z}^{_{local}}). It is necessary to “scale” the x- and y-coordinates from the coordinate system of the multi-level tiled map to the coordinate system of the tile pyramid. So, in the example, (x_{local}, y_{local}) will be (638−319*2, 105−52*2)=(0, 1). As mentioned above, the tile pyramid at zoom level z_{local} comprises 4 tiles with x- and y-coordinates (638, 104), (638, 105), (639, 104), and (639, 105) within the coordinate system of the multi-level tiled map. These tiles have x- and y-coordinates (0, 0), (0, 1), (1, 0), and (1, 1) within the coordinate system of the tile pyramid.

In this embodiment, in the step of determining the sequence number (seq), determining the sequence number (seq) as

$$seq = {\sum }_{i = 0}^{{z}_{l o c a l} - 1} {4}^{i} + {y}_{local} * {2}^{{z}_{local}} + {x}_{local} if {z}_{local} > 0 ,$$

and determining the sequence number (seq) as 0 if z_{local}=0. The data pointers comprised in the geographic metadata of the computer-implemented data structure are sorted based on the coordinates (z_{local}, y_{local}, x_{local}). Then, to retrieve the data pointer to a data location, within the geographic data, of the geographic tile data associated with a tile of the tile pyramid of the multi-level tiled map with coordinates (x_{local}, y_{local}, z_{local})=(1, 2, 2), it is deduced that a sequence number of the data pointer within the geographic metadata is (1+4)+8+1=14. This is because there is 1 data pointer for a tile at zoom level 0, 4 data pointers for tiles at zoom level 1, 8 data pointers for tiles at zoom level 2 which have a y-value smaller than 2 (i.e., 4 tiles at zoom level 2 with a y-value of 0 and 4 tiles at zoom level 1 with a y-value of 1), and 1 data pointer for a tile at zoom level 2 with y-value 2 with an x-value smaller than 1 (i.e., 1 tile at zoom level 2 with a y-value of 2 and an x-value of 0). Thus, the coordinates (1, 2, 2) define a sequence number 14 of the data pointer within the geographic metadata.

In a preferential variant of this embodiment, the data pointer comprises a start memory address offset and an end memory address offset. Further, in this preferential variant, the data pointer has a fixed size, for example wherein the fixed size is 16 bytes and the start memory address offset and the end memory address offset have a fixed equal size, for example wherein the fixed equal size is 8 bytes. Once the sequence number of the data pointer within the geographic metadata is determined, for example to be 14 as in the example above, then the memory address of the data pointer, relative to the start memory address of the computer-implemented data structure, can be computed as 14*16=224. So, to retrieve the data pointer of the tile of the tile pyramid of the multi-level tiled map with coordinates (1, 2, 2), the 224^{th} byte until the 240^{th} byte of the geographic metadata needs to be read.

The skilled Person understands that the data pointers within the geographic metadata can be sorted based on any permutation of the coordinates of the tiles, for example based on (x, y, z) or (y, x, z), and the formula to define the metadata location of the data pointer of a particular tile is trivially adapted to such a sorting scheme. Further, it is understood by the skilled person that the coordinate system of the tile pyramid of the multi-level tiled map is not necessarily 0-based, but can for example also be 1-based, and in such cases the formulate to define the metadata location of the data pointer of a particular tile is trivially adapted.

In an ninth aspect, the invention pertains to a geographic information system, comprising:
a computer-implemented data structure for storing and retrieving geographic data organized in a tile pyramid of a multi-level tiled map according to the first aspect of the invention or a computer-readable storage medium according to the second aspect of the invention;
a user request module comprising a user request interface for receiving user requests; wherein the user request module is configured to:
   in response to the user request interface receiving a user request for storing geographic data comprised in the tile pyramid of the multi-level tiled map, execute a computer-implemented method according to the fifth aspect of the invention;
   in response to the user request interface receiving a user request for retrieving geographic tile data associated with the tile of the tile pyramid of a multi-level tiled map, execute a computer-implemented method according to the sixth aspect of the invention.

In an tenth aspect, the invention pertains to a geographic information system, comprising:
a computer-implemented data structure collection for storing and retrieving geographic data of a multi-level tiled map according to the third aspect of the invention or a computer-readable storage medium according to the fourth aspect of the invention;
a user request module comprising a user request interface for receiving user requests; wherein the user request module is configured to:
   in response to the user request interface receiving a user request for storing geographic data comprised in the multi-level tiled map, execute a computer-implemented method according to the seventh aspect of the invention;
   in response to the user request interface receiving a user request for retrieving geographic tile data associated with the tile of the tile pyramid of a multi-level tiled map, execute a computer-implemented method according to the eighth aspect of the invention.

In an eleventh aspect, the invention pertains to a computer program, comprising instructions which, when the computer program is executed by a computer, cause the computer to carry out the steps of the method of the fifth, sixth, seventh, and/or the eighth aspect of the invention.

### BRIEF DESCRIPTION OF THE DRAWINGS

The invention is described below with reference to the figures. These figures serve as examples to illustrate the invention, and will not be construed as limiting the scope of the claims. In the different figures, like features are indicated by the like reference numerals.

In the figures:

FIG. 1a schematically shows a tile pyramid of a multi-level tiled map, the geographic data comprised in the tile pyramid of the multi-level tiled map being storable and/or retrievable and/or stored and/or retrieved using aspects of the invention.

FIG. 1b schematically shows a layout of a computer-implemented data structure for storing and retrieving geographic data comprised in the tile pyramid shown in FIG. 1a.

FIG. 2a schematically shows a multi-level tiled map comprising a plurality of tile pyramids, the geographic data comprised in the tile pyramids of the multi-level tiled map being storable and/or retrievable and/or stored and/or retrieved using aspects of the invention.

FIG. 2b schematically shows a layout of a data structure collection for storing and retrieving geographic data comprised in the tile pyramids shown in FIG. 2a.

### DETAILED DESCRIPTION

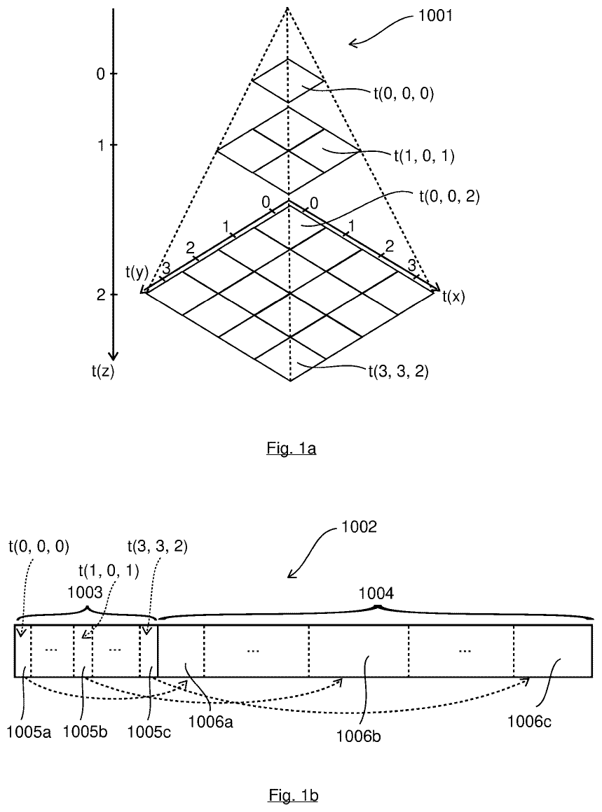

FIG. 1a schematically shows a tile pyramid 1001 of a multi-level tiled map. The coordinate system of the tile pyramid is shown in three dimensions t(x), t(y), and t(z). The tile pyramid comprises 3 zoom levels: 0, 1, and 2. Zoom level 0 comprises 1 tile, t(0, 0, 0). Zoom level 1 comprises 4 tiles, including t(1, 0, 1). Zoom level 2 comprises 16 tiles, including t(3, 3, 2). Each tile comprises geographic data (not shown).

FIG. 1b schematically shows a layout of a computer-implemented data structure 1002 for storing and retrieving geographic data comprised in the tile pyramid 1001 shown in FIG. 1a.

The computer-implemented data structure 1002 comprises geographic metadata 1003 and geographic data 1004. The geographic data 1004 comprises geographic tile data 1006a, 1006b, and 1006c corresponding to the geographic data associated with the tiles t(0, 0, 0), t(1, 0, 1) and t(3, 3, 2) respectively. Thus, geographic tile data 1006a, 1006b, and 1006c are memory locations, or slots, within the geographic data 1004 that each contain geographic data associated with a respective tile of the tile pyramid 1001.

The geographic tile data associated with each tile is an uninterrupted sequence of bytes. The size of the geographic tile data associated with each tile can differ; as shown in the figure, some tiles are associated with more geographic data than others.

The geographic metadata 1003 comprises data pointers 1005a, 1005b, 1005c to data locations, within the geographic data, of the geographic tile data associated with the tiles of the tile pyramid 1001. The data pointers 1005a, 1005b, 1005c point to data locations of geographic tile data 1006a, 1006b, and 1006c corresponding to the geographic data associated with the tiles t(0, 0, 0), t(1, 0, 1) and t(3, 3, 2) respectively. The data pointers 1005a, 1005b, 1005c have a fixed equal size, for example 16 bytes. Each data pointer 1005a, 1005b, 1005c comprises information to locate geographic tile data 1006a, 1006b, and 1006c, respectively. For example, the data locations each comprise a start memory address offset and an end memory address offset of the geographic tile data 1006a, 1006b, and 1006c, respectively. The start memory address offset corresponds to the first byte of the respective geographic tile data, and the end memory address offset corresponds to the last byte of the respective geographic tile data.

The data pointers comprised in the geographic metadata 1003 are sorted based on the coordinates (z, y, x), wherein z is the zoom level of each respective tile in the tile pyramid, y is the y-coordinate of each respective tile in the tile pyramid on the zoom level z, wherein 0<=y<2^{z}, and x is the x-coordinate of each respective tile in the tile pyramid on the zoom level z, wherein 0<=x<2^{z}. So, the data pointer 1005a to data location 1006a of the geographic tile data associated with tile t(0, 0, 0) is the first data pointer in the geographic metadata and has sequence number and metadata location 0, while the data pointer 1005c to data location 1006c of the geographic tile data associated with tile t(3, 3, 2) is the last data pointer in the geographic metadata and has sequence number 20. Thus, to retrieve the tile data associated to a tile with coordinates (x, y, z), the sequence number seq is computed as

$${\sum }_{i = 0}^{z - 1} {4}^{i} + ( y * {2}^{z} ) + x if z > 0$$

and the sequence number seq is computed as 0 if z=0. Since the size of the data pointers comprised in the geographic metadata is fixed, the metadata location of the data pointer comprising information to locate the geographic tile data associated with the tile with coordinates (x, y, z) is computed by multiplying the sequence number by the data pointer size, for example by computing seq*16 in case the size of the data pointers is 16 bytes.

Once the data location of the geographic tile data associated with the tile with coordinates (x, y, z) pointed to by the data pointer is known, the geographic tile data can readily be retrieved from the geographic data 1004.

The computer-implemented data structure 1002 is for example stored on a computer-readable storage medium, for example a hard disk, USB stick, or in random-access memory (RAM).

To store geographic data comprised in the tile pyramid 1001 in the computer-implemented data structure 1002, a computer-implemented method comprises the step of storing, within the geographic data 1004 of the computer-implemented data structure 1002, geographic tile data, including geographic tile data 1006a, 1006b, 1006c, associated with the tiles of the tile pyramid of the multi-level tiled map, including tiles t(0, 0, 0), t(1, 0, 1) and t(3, 3, 2). The computer-implemented method further comprises the step of storing, within the geographic metadata 1003 of the computer-implemented data structure 1002, data pointers, including data pointers 1005a, 1005b, 1005c to data locations, including data locations 1006a, 1006b, 1006c, within the geographic data 1004, of geographic tile data, including geographic tile data 1006a, 1006b, 1006c, associated with each respective tile, including tiles t(0, 0, 0), t(1, 0, 1) and t(3, 3, 2) of the tile pyramid 1001.

To retrieve geographic tile data associated with a tile of the tile pyramid 1001 from the computer-implemented data structure 1002, a computer-implemented method comprises the step of receiving, in a coordinate system of the tile pyramid of the multi-level tiled map, coordinates (x, y, z) of the tile of the tile pyramid of the multi-level tiled map to be retrieved.

The computer-implemented method further comprises the step of determining a sequence number seq based on the coordinates, in the tile coordinate system of the tile pyramid of the multi-level tiled map, of the tile of the tile pyramid of the multi-level tiled map to be retrieved. The sequence number seq is computed as

$${\sum }_{i = 0}^{z - 1} {4}^{i} + ( y * {2}^{z} ) + x if z > 0$$

and the sequence number seq is computed as 0 if z=0. For example, the data pointer for tile t(1, 0, 1) has sequence number 2.

The computer-implemented method further comprises the step of retrieving, from a metadata location within the geographic metadata associated with the sequence number seq comprised in the computer-implemented data structure storing geographic data of the tile pyramid of the multi-level tiled map, a data pointer to a data location of geographic tile data associated with the tile of the tile pyramid of the multi-level tiled map to be retrieved. For example, the metadata location associated with the sequence number 2 is 32. The data pointer in the example points to a data location associated with the geographic tile data 1006b.

The computer-implemented method further comprises the step of retrieving, from the data location of the geographic tile data associated with the tile of the tile pyramid of the multi-level tiled map to be retrieved within the geographic data of the computer-implemented data structure storing the geographic data of the tile pyramid of the multi-level tiled map, geographic tile data associated with the tile of the tile pyramid of the multi-level tiled map to be retrieved. In the example, the geographic tile data 1006b is retrieved from the geographic data 1004.

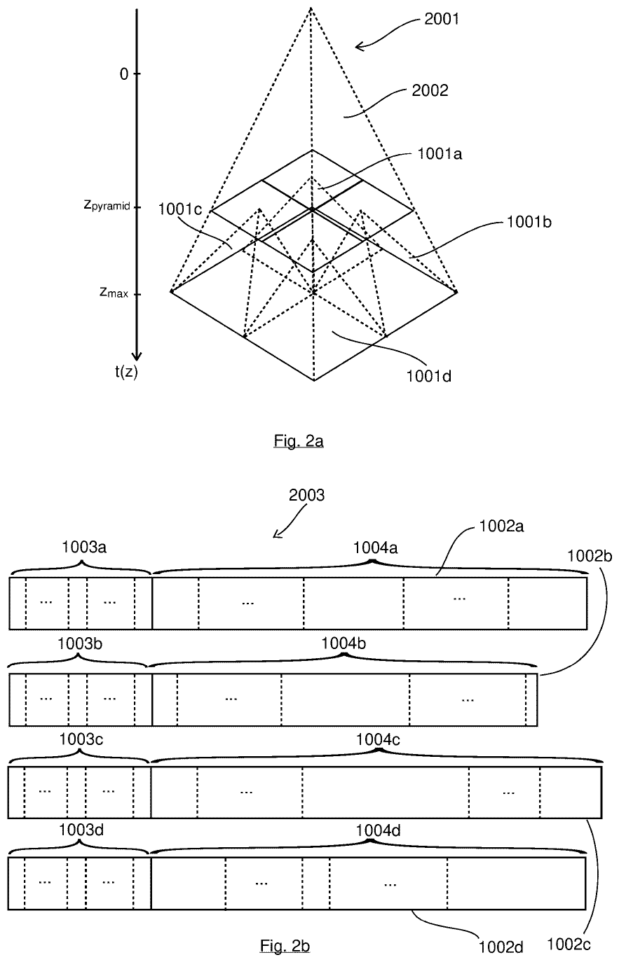

FIG. 2a schematically shows a multi-level tiled map 2001 comprising a plurality of tile pyramids 1001a, 1001b, 1001c, 1001d. Each tile pyramid 1001a, 1001b, 1001c, 1001d has as its top-level tile a tile on zoom level z_{pyramid} in the coordinate system of the multi-level tiled map 2001. Each tile pyramid 1001a, 1001b, 1001c, 1001d has as its bottom-level tile a number of tiles on the bottom-most zoom level zₘₐₓ of the multi-level tiled map 2001. Thus, the tile pyramids have a height (i.e., a total number of zoom levels) equal to zₘₐₓ−z_{pyramid}+1 (in other words, the height of the tile pyramids is equal to zₜₒₜₐₗ−z_{pyramid}).

FIG. 2b schematically shows a layout of a data structure collection 2003 for storing and retrieving geographic data comprised in the tile pyramids 1001a, 1001b, 1001c, 1001d shown in FIG. 2a.

The computer-implemented data structure collection 2003 comprises a plurality of computer-implemented data structures 1002a, 1002b, 1002c, 1002d. Each computer-implemented data structure 1002a, 1002b, 1002c, 1002d is suitable for storing and retrieving geographic data organized tile pyramids 1001a, 1001b, 1001c, 1001d, respectively. A triple formed by coordinates of a tile of the multi-level tiled map in the tile coordinate system of the multi-level tiled map, the total number of zoom levels of the multi-level tiled map zₜₒₜₐₗ, and the single zoom level z_{pyramid}, define a data structure collection location, within the computer-implemented data structure collection, of the computer-implemented data structure comprising geographic tile data associated with the tile of the multi-level tiled map. For example, for a tile with coordinates (x, y, z) in the coordinate system of the multi-level map, the data structure collection location points to one of the computer-implemented data structures 1002a, 1002b, 1002c, 1002d in which the geographic tile data associated with the tile is located.

To store geographic data comprised in the multi-level tiled map 2001 in the computer-implemented data structure collection 2003, a computer-implemented method comprises the step of determining the zoom level z_{pyramid} of the multi-level tiled map 2001. The computer-implemented method further comprises the step of storing, in each computer-implemented data structure 1002a, 1002b, 1002c, 1002d of the computer-implemented data structure collection 2003, geographic data comprised in the tile pyramids 1001a, 1001b, 1001c, 1001d, respectively, using a computer-implemented method for storing geographic data comprised in the tile pyramid 1001 in the computer-implemented data structure 1002 as explained in the context of FIG. 1a and FIG. 1b.

The computer-implemented data structure collection 2003 optionally further comprises a further computer-implemented data structure for storing and retrieving a further tile pyramid 2002 comprising, as its top-level tile, a top-level tile of the multi-level tiled map 2001, and comprising, as its bottom-level tiles, all tiles comprised in zoom level z_{pyramid}−1 of the multi-level tiled map 2001.

The computer-implemented data structure collection 2003 is for example stored on a computer-readable storage medium, for example on a hard disk or a USB stick as a plurality of files within a folder, or in random-access memory (RAM) as a sequence of bytes.

To retrieve a tile of the multi-level tiled map 2001 from the computer-implemented data structure collection 2003, a computer-implemented method comprises the step of receiving, in a coordinate system of the multi-level tiled map 2001, the coordinates of the tile of the multi-level tiled map 2001 to be retrieved. For example, if z_{pyramid}=2 and zₘₐₓ=4, the coordinates of the tile of the multi-level tiled map 2001 to be retrieved are for example (11, 10, 4). It is determined here that the zoom level comprising the tile of the multi-level tiled map zₜᵢₗₑ>z_{pyramid}.

The computer-implemented method further comprises the step of retrieving, from the computer-implemented data structure collection, a computer-implemented data structure storing geographic data of a tile pyramid of the multi-level tiled map comprising the tile of the multi-level tiled map to be retrieved. In this case, the zoom level z_{local} within the tile pyramid comprising the tile of the multi-level tiled map to be retrieved is determined to be z_{local}=Z−z_{pyramid}=2. Then, the coordinates of the top-level tile of the tile pyramid at the zoom level z_{pyramid} of the multi-level tiled map as

$$( {x}_{pyramid} , {y}_{pyramid} ) = ( floor ( \frac{x}{{2}^{{z}_{local}}} ) , floor ( \frac{y}{{2}^{{z}_{local}}} ) ) = ( 2 , 2 ) .$$

Then, the coordinates (x_{local}, y_{local}) of the tile within the tile pyramid are determined as (x_{local}, y_{local})=(x−x_{pyramid}*2^{z}^{_{local}}, y−y_{pyramid}*2^{z}^{_{local}})=(3, 2). Thus, the computer-implemented data structure storing geographic data of the tile pyramid starting at tile (2, 2, 2) in the coordinate system of the multi-level tiled map 2001 has to be retrieved. Then, within that computer-implemented data structure, the geographic tile data is retrieved by computing the sequence number seq as

$${\sum }_{i = 0}^{{z}_{local} - 1} {4}^{i} + {y}_{local} * {2}^{{z}_{local}} + {x}_{local} if {z}_{local} > 0 ,$$

and computing the sequence number seq as 0 if z_{local}=0 and using the computer-implemented method for retrieving geographic tile data associated with the tile of the tile pyramid 1001 as explained in the context of FIG. 1a and FIG. 1b.

Embodiments and further embodiments of the present invention—which (further) embodiments may be broader than claimed in the claims—may be expressed in words as set out in the following clauses:
1] A computer-implemented data structure for storing and retrieving geographic data organized in a tile pyramid of a multi-level tiled map, the multi-level tiled map having a total number of zoom levels (zₜₒₜₐₗ), the computer-implemented data structure comprising:
   geographic data comprising geographic tile data associated with a tile of the tile pyramid of the multi-level tiled map;
   geographic metadata comprising a data pointer to a data location, within the geographic data, of the geographic tile data associated with the tile of the tile pyramid of the multi-level tiled map;

wherein:
coordinates of the tile of the tile pyramid of the multi-level tiled map in a tile coordinate system of the tile pyramid of the multi-level tiled map define a metadata location, within the geographic metadata, of the data pointer to the data location of the geographic tile data associated with the tile of the tile pyramid of the multi-level tiled map.
2] Computer-implemented data structure according to clause 1, wherein the computer-implemented data structure is read-only.
3] Computer-implemented data structure according to any one of the previous clauses, wherein the geographic metadata is comprised in a header of the computer-implemented data structure.
4] Computer-implemented data structure according to any one of the previous clauses, wherein the data pointer comprises a start memory address offset and an end memory address offset.
5] Computer-implemented data structure according to clause 4, wherein:
   the data pointer has a fixed size, for example wherein the fixed size is 16 bytes; and
   the start memory address offset and the end memory address offset have a fixed equal size, for example wherein the fixed equal size is 8 bytes.
6] Computer-implemented data structure according to any one of the previous clauses, wherein the tile pyramid comprises all tiles of i zoom levels of the multi-level tiled map, preferably the last i zoom levels of the multi-level tiled map, wherein i is an integer, wherein 0<i<=zₜₒₜₐₗ, wherein zₜₒₜₐₗ is the total number of zoom levels of the multi-level tiled map, for example wherein i is 5.
7] Computer-implemented data structure according to any one of the previous clauses, wherein:
   the geographic data comprises geographic tile data associated with all tiles of the tile pyramid of the multi-level tiled map;
   the geographic metadata comprises, for all tiles of the tile pyramids of the multi-level tiled map, a respective data pointer to a respective data location of geographic tile data associated with a respective tile of the tile pyramid of the multi-level tiled map;
   the data pointers comprised in the geographic metadata are sorted based on coordinates, in the tile coordinate system of the tile pyramid of the multi-level tiled map, of the tiles of the tile pyramid of the multi-level tiled map, the coordinates of the tiles of the tile pyramid of the multi-level tiled map defining, within the geographic metadata, the metadata locations of the data pointers to the data locations of the geographic tile data associated with each respective tile of the tile pyramid of the multi-level tiled map.
8] Computer-implemented data structure according to clause 7, wherein the data pointers comprised in the geographic metadata are sorted based on the coordinates (z, y, x), wherein z is the zoom level of each respective tile in the tile pyramid, y is the y-coordinate of each respective tile in the tile pyramid on the zoom level z, wherein 0<=y<2^{z}, and x is the x-coordinate of each respective tile in the tile pyramid on the zoom level z, wherein 0<=x<2^{z}.
9] Computer-implemented data structure according to clause 6 and clause 8, wherein 0<=z<i.
10] Computer-implemented data structure according to any one of clauses 8-9, wherein the metadata location is defined based on a sequence number (seq), the sequence number (seq) being defined as

$${\sum }_{i = 0}^{z - 1} {4}^{i} + ( y * {2}^{z} ) + x if z > 0$$

and the sequence number (seq) being defined as 0 if z=0.
11] A computer-readable storage medium storing, in a computer-implemented data structure according to any one of clauses 1-10, geographic data organized in the tile pyramid of the multi-level tiled map.
12] A computer-implemented data structure collection for storing and retrieving geographic data of a multi-level tiled map comprising a plurality of tile pyramids, the computer-implemented data structure collection comprising a plurality of computer-implemented data structures according to any one of clauses 1-10, wherein:
   each computer-implemented data structure is suitable for storing and retrieving geographic data organized in a respective tile pyramid, wherein the respective tile pyramid comprises, as its top-level tile, a respective tile of the multi-level tiled map;
   a single zoom level (z_{pyramid}) of the multi-level tiled map comprises the top-level tile of all tile pyramids of the multi-level tiled map, wherein 0<z_{pyramid}<zₜₒₜₐₗ;
   a triple formed by coordinates of a tile of the multi-level tiled map in the tile coordinate system of the multi-level tiled map, the total number of zoom levels of the multi-level tiled map (zₜₒₜₐₗ), and the single zoom level (z_{pyramid}), define a data structure collection location, within the computer-implemented data structure collection, of the computer-implemented data structure comprising geographic tile data associated with the tile of the multi-level tiled map.
13] Computer-implemented data structure collection according to clause 12, further comprising a further computer-implemented data structure according to any one of clauses 1-10 for storing and retrieving a further tile pyramid comprising, as its top-level tile, a top-level tile of the multi-level tiled map, and comprising, as its bottom-level tiles, all tiles comprised in zoom level z_{pyramid}−1.
14] A computer-readable storage medium storing, in a computer-implemented data structure collection according to any one of clauses 12-13, geographic data comprised in a multi-level tiled map comprising a plurality of tile pyramids.
15] A computer-implemented method for storing geographic data comprised in a tile pyramid of a multi-level tiled map in a computer-implemented data structure according to any one of clauses 1-10 or on a computer-readable storage medium according to clause 11, the computer-implemented method comprising the step of:
   storing, within the geographic data of the computer-implemented data structure, geographic tile data associated with the tiles of the tile pyramid of the multi-level tiled map;
   storing, within the geographic metadata of the computer-implemented data structure, data pointers to data locations, within the geographic data, of geographic tile data associated with each respective tile of the tile pyramid of the multi-level tiled map.
16] A computer-implemented method for retrieving geographic tile data associated with a tile of a tile pyramid of a multi-level tiled map from a computer-implemented data structure according to any one of clauses 1-10 or from a computer-readable medium according to clause 11, the method comprising the steps of:
   receiving, in a coordinate system of the tile pyramid of the multi-level tiled map, the coordinates of the tile of the tile pyramid of the multi-level tiled map to be retrieved;
   determining a sequence number (seq) based on the coordinates, in the tile coordinate system of the tile pyramid of the multi-level tiled map, of the tile of the tile pyramid of the multi-level tiled map to be retrieved;
   retrieving, from a metadata location within the geographic metadata associated with the sequence number (seq) comprised in the computer-implemented data structure storing geographic data of the tile pyramid of the multi-level tiled map, a data pointer to a data location of geographic tile data associated with the tile of the tile pyramid of the multi-level tiled map to be retrieved;
   retrieving, from the data location of the geographic tile data associated with the tile of the tile pyramid of the multi-level tiled map to be retrieved within the geographic data of the computer-implemented data structure storing the geographic data of the tile pyramid of the multi-level tiled map, geographic tile data associated with the tile of the tile pyramid of the multi-level tiled map to be retrieved.
17] Computer-implemented method according to clause 16, wherein:
   the coordinates of the tile of the tile pyramid of the multi-level tiled map to be retrieved are (x, y, z), wherein z is the zoom level of the tile of the tile pyramid, x is the x-coordinate of the tile of the tile pyramid on the zoom level z of the tile pyramid, wherein 0<=x<2^{z} and y is the y-coordinate of the tile of the tile pyramid on the zoom level z, wherein 0<=y<2^{z};
   in the step of determining the sequence number (seq), determining the sequence number (seq) as

$$seq = {\sum }_{i = 0}^{z - 1} {4}^{i} + ( y * {2}^{z} ) + x if z > 0 ,$$

and determining the sequence number (seq) as 0 if z=0.
18] A computer-implemented method for storing geographic data comprised in a multi-level tiled map in a computer-implemented data structure collection according to any one of clause 12-13 or on a computer-readable storage medium according to clause 14, wherein the computer-implemented data structure collection comprises a plurality of computer-implemented data structures according to any one of clauses 1-10, the computer-implemented method comprising the steps of:
   determining the single zoom level (z_{pyramid}) of the multi-level tiled map;
   storing, in each computer-implemented data structure of the computer-implemented data structure collection, geographic data comprised in a tile pyramid comprising, as its top-level tile, a respective tile of the multi-level tiled map comprised in the single zoom level (z_{pyramid}) of the multi-level tiled map, and comprising, as its bottom-level tiles, respective tiles of the multi-level tiled map comprised in zoom level zₜₒₜₐₗ−1, wherein zₜₒₜₐₗ is the total number of zoom levels of the multi-level tiled map, using a computer-implemented method according to clause 15.
19] A computer-implemented method for retrieving a tile of a multi-level tiled map from a computer-implemented data structure collection according to any one of clauses 12-13 or from a computer-readable storage medium according to clause 14, the method comprising the steps of:
   receiving, in a coordinate system of the multi-level tiled map, the coordinates of the tile of the multi-level tiled map to be retrieved;
   if it is determined that a zoom level comprising the tile of the multi-level tiled map (zₜᵢₗₑ) is larger than or equal to the single zoom level (z_{pyramid}):
      retrieving, from the computer-implemented data structure collection, a computer-implemented data structure storing geographic data of a tile pyramid of the multi-level tiled map comprising the tile of the multi-level tiled map to be retrieved;
      determining, in the coordinate system of the tile pyramid of the multi-level tiled map, coordinates of the tile of the tile pyramid of the multi-level tiled map to be retrieved, based on the coordinates, in the coordinate system of the multi-level tiled map, of the tile of the multi-level tiled map to be retrieved;
      retrieving, from the computer-implemented data structure storing geographic data of the tile pyramid of the multi-level tiled map comprising the tile of the multi-level tiled map to be retrieved, geographic tile data associated with the tile of the tile pyramid of the multi-level tiled map using a computer-implemented method according to any one of clauses 16-17.
20] Computer-implemented method according to clause 19, wherein:
   the computer-implemented data structure collection is a computer-implemented data structure collection according to clause 13;
   if it is determined that the zoom level comprising the tile of the multi-level tiled map (zₜᵢₗₑ) is smaller than the single zoom level (z_{pyramid}):
      determining, in the coordinate system of the further tile pyramid of the multi-level tiled map, coordinates of the tile of the further tile pyramid of the multi-level tiled map, based on the coordinates, in the coordinate system of the multi-level tiled map, of the tile of the multi-level tiled map to be retrieved;
      retrieving, from the further tile pyramid, geographic tile data associated with the tile of the tile pyramid of the multi-level tiled map using a computer-implemented method according to any one of clauses 16-17.
21] Computer-implemented method according to any one of clauses 19-20, wherein:
   the coordinates of the tile of the multi-level tiled map to be retrieved are (x, y, z), wherein z is the zoom level of the tile of the multi-level tiled map, x is the x-coordinate of the tile of the multi-level tiled map on the zoom level z, wherein 0<=x<2^{z} and y is the y-coordinate of the tile of the multi-level tiled map on the zoom level z, wherein 0<=y<2^{z};
   in the step of retrieving, from the computer-implemented data structure collection, the computer-implemented data structure storing geographic data of the tile pyramid of the multi-level tiled map comprising the tile of the multi-level tiled map to be retrieved, retrieving the computer-implemented data structure storing geographic data of the tile pyramid having as its top-level tile the tile with coordinates (x_{pyramid}, y_{pyramid}) at zoom level z_{pyramid} of the multi-level tiled map;
   in the step of determining, in the coordinate system of the tile pyramid of the multi-level tiled map, coordinates of the tile of the tile pyramid of the multi-level tiled map, based on the coordinates, in the coordinate system of the multi-level tiled map, of the tile of the multi-level tiled map to be retrieved, the method further comprises the steps of:
      determining a zoom level z_{local} within the tile pyramid, the zoom level z_{local} comprising the tile of the multi-level tiled map to be retrieved, wherein z_{local}=Z−z_{pyramid};
      determining the coordinates of the top-level tile of the tile pyramid at the zoom level z_{pyramid} of the multi-level tiled map as

$$( {x}_{pyramid} , {y}_{pyramid} ) = ( floor ( \frac{x}{{2}^{{z}_{local}}} ) , floor ( \frac{y}{{2}^{{z}_{local}}} ) ) ;$$

determining the coordinates (x_{local}, y_{local}) of the tile within the tile pyramid as

$$( {x}_{local} , {y}_{local} ) = ( x - {x}_{pyramid} * {2}^{{z}_{local}} , y - {y}_{pyramid} * {2}^{{z}_{local}} ) ;$$

in the step of determining the sequence number (seq), determining the sequence number (seq) as

$$seq = {\sum }_{i = 0}^{{z}_{local} - 1} {4}^{i} + {y}_{local} * {2}^{{z}_{local}} + {x}_{local} if {z}_{local} > 0 ,$$

and determining the sequence number (seq) as 0 if z_{local}=0.
22] A geographic information system, comprising:
   a computer-implemented data structure for storing and retrieving geographic data organized in a tile pyramid of a multi-level tiled map according to any one of clauses 1-10 or a computer-readable storage medium according to clause 11;
   a user request module comprising a user request interface for receiving user requests;
   wherein the user request module is configured to:
      in response to the user request interface receiving a user request for storing geographic data comprised in the tile pyramid of the multi-level tiled map, execute a computer-implemented method according to clause 15;
      in response to the user request interface receiving a user request for retrieving geographic tile data associated with the tile of the tile pyramid of a multi-level tiled map, execute a computer-implemented method according to any one of clauses 16-17.
23] A geographic information system, comprising:
   a computer-implemented data structure collection for storing and retrieving geographic data of a multi-level tiled map according to any one of clauses 12-13 or a computer-readable storage medium according to clause 14;
   a user request module comprising a user request interface for receiving user requests;
   wherein the user request module is configured to:
      in response to the user request interface receiving a user request for storing geographic data comprised in the multi-level tiled map, execute a computer-implemented method according to clause 18;
      in response to the user request interface receiving a user request for retrieving geographic tile data associated with the tile of the tile pyramid of a multi-level tiled map, execute a computer-implemented method according to any one of clauses 19-21.
24] A computer program, comprising instructions which, when the computer program is executed by a computer, cause the computer to carry out the steps of the method of any one of the clauses 15-21.

1-24. (canceled)

25. A computer-readable storage medium storing geographic data organized in a tile pyramid of a multi-level tiled map having a total number of zoom levels, zₜₒₜₐₗ, in a computer-implemented data structure for storing and retrieving geographic data, the computer-implemented data structure comprising:
geographic data comprising geographic tile data associated with a tile of the tile pyramid of the multi-level tiled map; and
geographic metadata comprising a data pointer to a data location, within the geographic data, of the geographic tile data associated with the tile of the tile pyramid of the multi-level tiled map;
wherein:
coordinates of the tile of the tile pyramid of the multi-level tiled map in a tile coordinate system of the tile pyramid of the multi-level tiled map define a metadata location, within the geographic metadata, of the data pointer to the data location of the geographic tile data associated with the tile of the tile pyramid of the multi-level tiled map.

26. The computer-readable storage medium according to claim 25, wherein the computer-implemented data structure is read-only.

27. The computer-readable storage medium according to claim 25, wherein the geographic metadata is comprised in a header of the computer-implemented data structure.

28. The computer-readable storage medium according to claim 25, wherein the data pointer comprises a start memory address offset and an end memory address offset.

29. The computer-readable storage medium according to claim 28, wherein:
the data pointer has a fixed size; and
the start memory address offset and the end memory address offset have a fixed equal size.

30. The computer-readable storage medium according to claim 25, wherein the tile pyramid comprises all tiles of i zoom levels of the multi-level tiled map, wherein i is an integer, wherein 0<i>zₜₒₜₐₗ, wherein zₜₒₜₐₗ is the total number of zoom levels of the multi-level tiled map.

31. The computer-readable storage medium according to claim 25, wherein:
the geographic data comprises geographic tile data associated with all tiles of the tile pyramid of the multi-level tiled map;
the geographic metadata comprises, for all tiles of the tile pyramids of the multi-level tiled map, a respective data pointer to a respective data location of geographic tile data associated with a respective tile of the tile pyramid of the multi-level tiled map; and
the data pointers of the geographic metadata are sorted based on coordinates, in the tile coordinate system of the tile pyramid of the multi-level tiled map, of the tiles of the tile pyramid of the multi-level tiled map, the coordinates of the tiles of the tile pyramid of the multi-level tiled map defining, within the geographic metadata, the metadata locations of the data pointers to the data locations of the geographic tile data associated with each respective tile of the tile pyramid of the multi-level tiled map.

32. The computer-readable storage medium according to claim 31, wherein the data pointers of the geographic metadata are sorted based on the coordinates, which include z, y, and x, wherein z is the zoom level of each respective tile in the tile pyramid, y is the y-coordinate of each respective tile in the tile pyramid on the zoom level z, wherein 0≤y<2^{z}, and x is the x-coordinate of each respective tile in the tile pyramid on the zoom level z, wherein 0≤x<2^{z}.

33. The computer-readable storage medium according to claim 32, wherein the tile pyramid comprises all tiles of i zoom levels of the multi-level tiled map, wherein i is an integer, wherein 0<i>zₜₒₜₐₗ, wherein zₜₒₜₐₗ is the total number of zoom levels of the multi-level tiled map.

34. The computer-readable storage medium according to claim 32, wherein the metadata location is defined based on a sequence number, seq, the sequence number, seq, being defined as
$${\sum }_{\text{?}}^{\text{?}} {4}^{\text{?}} + ( y + {2}^{\text{?}} ) + x if z > 0$$
$$\text{?} \text{indicates text missing or illegible when filed}$$
and the sequence number, seq, being defined as 0 if z=0.

35. The computer-readable storage medium according to claim 25, storing a plurality of the computer-implemented data structures for storing and retrieving geographic data, wherein:
each computer-implemented data structure is suitable for storing and retrieving geographic data organized in a respective tile pyramid, wherein the respective tile pyramid comprises, as its top-level tile, a respective tile of the multi-level tiled map;
a single zoom level, z_{pyramid}, of the multi-level tiled map comprises the top-level tile of all tile pyramids of the multi-level tiled map, wherein 0<z_{pyramid}<zₜₒₜₐₗ;
a triple formed by coordinates of a tile of the multi-level tiled map in the tile coordinate system of the multi-level tiled map, the total number of zoom levels of the multi-level tiled map, zₜₒₜₐₗ, and the single zoom level, z_{pyramid}, identify, within the plurality of the computer-implemented data structures, the computer-implemented data structure comprising geographic tile data associated with the tile of the multi-level tiled map.

36. The computer-readable storage medium according to claim 35, further storing a further computer-implemented data structure for storing and retrieving geographic data, wherein the further data structure is suitable for storing and retrieving a further tile pyramid comprising, as its top-level tile, a top-level tile of the multi-level tiled map, and comprising, as its bottom-level tiles, all tiles comprised in zoom level z_{pyramid}−1.

37. A geographic information system, comprising:
a computer-readable storage medium according to claim 25;
a user request module comprising a user request interface for receiving user requests;
wherein the user request module is configured to:
in response to the user request interface receiving a user request for storing geographic data comprised in the tile pyramid of the multi-level tiled map, execute a computer-implemented method comprising the steps of:
storing, within the geographic data of the computer-implemented data structure stored on the computer-readable storage medium, geographic tile data associated with the tiles of the tile pyramid of the multi-level tiled map;
storing, within the geographic metadata of the computer-implemented data structure stored on the computer-readable storage medium, data pointers to data locations, within the geographic data, of geographic tile data associated with each respective tile of the tile pyramid of the multi-level tiled map.

38. The geographic information system of claim 37, the computer-readable storage medium storing a plurality of computer-implemented data structures for storing and retrieving geographic data, wherein each computer-implemented data structure is suitable for storing and retrieving geographic data organized in a respective tile pyramid, wherein the respective tile pyramid comprises, as its top-level tile, a respective tile of the multi-level tiled map; wherein:
a single zoom level, z_{pyramid}, of the multi-level tiled map comprises the top-level tile of all tile pyramids of the multi-level tiled map, wherein 0<z_{pyramid}<zₜₒₜₐₗ;
a triple formed by coordinates of a tile of the multi-level tiled map in the tile coordinate system of the multi-level tiled map, the total number of zoom levels of the multi-level tiled map, zₜₒₜₐₗ, and the single zoom level, z_{pyramid}, identifies, within the plurality of computer-implemented data structures for storing and retrieving geographic data, the computer-implemented data structure comprising geographic tile data associated with the tile of the multi-level tiled map;
the computer-implemented method further comprising the steps of:
determining the single zoom level, z_{pyramid}, of the multi-level tiled map;
storing, in each computer-implemented data structure of the plurality of the computer-implemented data structures, geographic data comprised in a tile pyramid comprising, as its top-level tile, a respective tile of the multi-level tiled map comprised in the single zoom level, z_{pyramid}, of the multi-level tiled map, and comprising, as its bottom-level tiles, respective tiles of the multi-level tiled map comprised in zoom level zₜₒₜₐₗ−1, wherein zₜₒₜₐₗ is the total number of zoom levels of the multi-level tiled map.

39. A geographic information system, comprising:
a computer-readable storage medium according to claim 25;
a user request module comprising a user request interface for receiving user requests;
wherein the user request module is configured to:
in response to the user request interface receiving a user request for retrieving geographic tile data associated with the tile of the tile pyramid of a multi-level tiled map, execute a computer-implemented method comprising the steps of:
receiving, in a coordinate system of the tile pyramid of the multi-level tiled map, the coordinates of the tile of the tile pyramid of the multi-level tiled map to be retrieved;
determining a sequence number, seq, based on the coordinates, in the tile coordinate system of the tile pyramid of the multi-level tiled map, of the tile of the tile pyramid of the multi-level tiled map to be retrieved;
retrieving, from a metadata location within the geographic metadata associated with the sequence number, seq, comprised in the computer-implemented data structure storing geographic data of the tile pyramid of the multi-level tiled map, a data pointer to a data location of geographic tile data associated with the tile of the tile pyramid of the multi-level tiled map to be retrieved;
retrieving, from the data location of the geographic tile data associated with the tile of the tile pyramid of the multi-level tiled map to be retrieved within the geographic data of the computer-implemented data structure storing the geographic data of the tile pyramid of the multi-level tiled map, geographic tile data associated with the tile of the tile pyramid of the multi-level tiled map to be retrieved.

40. The geographic information system according to claim 39, wherein:
the coordinates of the tile of the tile pyramid of the multi-level tiled map to be retrieved include x, y, and z, wherein z is the zoom level of the tile of the tile pyramid, x is the x-coordinate of the tile of the tile pyramid on the zoom level z of the tile pyramid, wherein 0<=x<2^{z} and y is the y-coordinate of the tile of the tile pyramid on the zoom level z, wherein 0<=y<2^{z};
in the step of determining the sequence number, seq, determining the sequence number, seq, as
$$seq = {\sum }_{i = 0}^{\text{?}} {4}^{\text{?}} + ( y * {2}^{\text{?}} ) + x if z > 0 ,$$
$$\text{?} \text{indicates text missing or illegible when filed}$$
and determining the sequence number, seq, as 0 if z=0.

41. The geographic information system according to claim 39, the computer-readable storage medium storing a plurality of computer-implemented data structures for storing and retrieving geographic data, wherein each computer-implemented data structure is suitable for storing and retrieving geographic data organized in a respective tile pyramid, wherein the respective tile pyramid comprises, as its top-level tile, a respective tile of the multi-level tiled map; wherein:
a single zoom level, z_{pyramid}, of the multi-level tiled map comprises the top-level tile of all tile pyramids of the multi-level tiled map, wherein 0<z_{pyramid}<zₜₒₜₐₗ;
a triple formed by coordinates of a tile of the multi-level tiled map in the tile coordinate system of the multi-level tiled map, the total number of zoom levels of the multi-level tiled map, zₜₒₜₐₗ, and the single zoom level, z_{pyramid}, identify, within the plurality of computer-implemented data structures for storing and retrieving geographic data, the computer-implemented data structure comprising geographic tile data associated with the tile of the multi-level tiled map;
the computer-implemented method further comprising the steps of:
receiving, in a coordinate system of the multi-level tiled map, the coordinates of the tile of the multi-level tiled map to be retrieved;
if it is determined that a zoom level comprising the tile of the multi-level tiled map, zₜᵢₗₑ, is larger than or equal to the single zoom level, z_{pyramid}:
retrieving, from the plurality of computer-implemented data structures, a computer-implemented data structure storing geographic data of a tile pyramid of the multi-level tiled map comprising the tile of the multi-level tiled map to be retrieved;
determining, in the coordinate system of the tile pyramid of the multi-level tiled map, coordinates of the tile of the tile pyramid of the multi-level tiled map to be retrieved, based on the coordinates, in the coordinate system of the multi-level tiled map, of the tile of the multi-level tiled map to be retrieved;
retrieving, from the computer-implemented data structure storing geographic data of the tile pyramid of the multi-level tiled map comprising the tile of the multi-level tiled map to be retrieved, geographic tile data associated with the tile of the tile pyramid of the multi-level tiled map.

42. The geographic information system according to claim 39, the computer-readable storage medium further storing a further computer-implemented data structure for storing and retrieving geographic data, wherein the further data structure is suitable for storing and retrieving a further tile pyramid comprising, as its top-level tile, a top-level tile of the multi-level tiled map, and comprising, as its bottom-level tiles, all tiles comprised in zoom level z_{pyramid}−1; the computer-implemented method further comprising the steps of:
if it is determined that the zoom level comprising the tile of the multi-level tiled map, Σₜᵢₗₑ, is smaller than the single zoom level, z_{pyramid}:
determining, in the coordinate system of the further tile pyramid of the multi-level tiled map, coordinates of the tile of the further tile pyramid of the multi-level tiled map, based on the coordinates, in the coordinate system of the multi-level tiled map, of the tile of the multi-level tiled map to be retrieved;
retrieving, from the further tile pyramid, geographic tile data associated with the tile of the tile pyramid of the multi-level tiled map.

43. The geographic information system according to claim 39, wherein the coordinates of the tile of the multi-level tiled map to be retrieved include x, y, and z, wherein z is the zoom level of the tile of the multi-level tiled map, x is the x-coordinate of the tile of the multi-level tiled map on the zoom level z, wherein 0<=x<2^{z} and y is the y-coordinate of the tile of the multi-level tiled map on the zoom level z, wherein 0<=y<2^{z};
in the step of retrieving, from the plurality of computer-implemented data structures, the computer-implemented data structure storing geographic data of the tile pyramid of the multi-level tiled map comprising the tile of the multi-level tiled map to be retrieved, retrieving the computer-implemented data structure storing geographic data of the tile pyramid having as its top-level tile the tile with coordinates (x_{pyramid}, y_{pyramid}) at zoom level z_{pyramid} of the multi-level tiled map;
in the step of determining, in the coordinate system of the tile pyramid of the multi-level tiled map, coordinates of the tile of the tile pyramid of the multi-level tiled map, based on the coordinates, in the coordinate system of the multi-level tiled map, of the tile of the multi-level tiled map to be retrieved, the method further comprises the steps of:
determining a zoom level z_{local} within the tile pyramid, the zoom level z_{local} comprising the tile of the multi-level tiled map to be retrieved, wherein z_{local}=Z−z_{pyramid};
determining the coordinates of the top-level tile of the tile pyramid at the zoom level z_{pyramid} of the multi-level tiled map as
$$( {x}_{pyramid} , {y}_{pyramid} ) = ( floor ( \frac{\text{?}}{{2}^{{\text{?}}_{\text{?}}}} ) , floor ( \frac{\text{?}}{{2}^{{\text{?}}_{\text{?}}}} ) ) ;$$
$$\text{?} \text{indicates text missing or illegible when filed}$$
determining the coordinates (x_{local}, y_{local}) of the tile within the tile pyramid as
$$( {x}_{local} , {y}_{local} ) = ( x - {x}_{\text{?}} * {2}^{{\text{?}}_{\text{?}}} , y - {y}_{pyramid} * {2}^{{\text{?}}_{\text{?}}} ) ;$$
$$\text{?} \text{indicates text missing or illegible when filed}$$
in the step of determining the sequence number, seq, determining the sequence number, seq, as
$$seq = {\sum }_{\text{?} = 0}^{{z}_{\text{?}} - 1} {4}^{\text{?}} + {y}_{\text{?}} * {2}^{{\text{?}}_{\text{?}}} + {x}_{\text{?}} if {z}_{local} > 0 ,$$
$$\text{?} \text{indicates text missing or illegible when filed}$$
and determining the sequence number, seq, as 0 if z_{local}=0.
